(19) United States
(12) Patent Application Publication
(10) Pub. No.: US 2011/0274531 A1
(43) Pub. Date: Nov. 10, 2011

(54) APPARATUS AND METHOD FOR LIFTING AND MOVING MERCHANDISE GONDOLAS

(75) Inventors: Curt Boelter, Henderson, MN (US); Cole Boelter, Henderson, MN (US)

(73) Assignee: OVER THE TOP INNOVATIONS, Henderson, MN (US)

(21) Appl. No.: 13/100,111

(22) Filed: May 3, 2011

Related U.S. Application Data
(60) Provisional application No. 61/331,721, filed on May 5, 2010.

(51) Int. Cl. B66F 5/02; B66F 3/46

(52) U.S. Cl. 414/800; 254/2 R

(57) ABSTRACT

Apparatus and method for lifting and moving a merchandise gondola that includes a plurality of lift units, each lift unit including a substantially vertical first member, a substantially vertical second member, a substantially horizontal third member removably connected to the first member and removably connected to the second member, a gondola-coupling device centrally located on the third member and configured to couple to a top surface of a merchandise gondola, and a mechanical-lift mechanism operatively coupled to the lift unit and configured to lift the gondola-coupling device in a vertical direction relative to the third member, wherein the mechanical-lift mechanism includes a rotary assembly coupled to the lift unit and configured to provide a two-way mechanically advantaged connection to the gondola-coupling device from the first member and configured to be actuated to lift the gondola-coupling device while the first member and the second member remain substantially vertical.

### CROSS-REFERENCE TO RELATED APPLICATIONS

This application claims priority benefit under 35 U.S.C. §119(e) to U.S. Provisional Patent Application No. 61/331,721 filed on May 5, 2010, titled “LIFTING DEVICE TO MOVE AND RELOCATE RETAIL SHELVING AND/OR GONDOLAS” by Curt Boelter, which is incorporated herein by reference in its entirety.

### FIELD OF THE INVENTION

The invention relates generally to shelf-moving systems, and more particularly to methods and apparatus for mechanically lifting merchandise gondolas from the top of the gondolas such that the gondolas can be moved from one location to another.

### BACKGROUND OF THE INVENTION

Gondola-type shelving is commonly used in many stores to display merchandise. The gondola typically has a plurality of upright posts to which horizontal shelves are attached for displaying merchandise. A leg extends from the base of each upright post to stabilize the post. A bottom or lower shelf is usually placed over the legs for additional display space. Normally, shelves and legs extend on opposite sides of the upright posts, with a wall extending between and connected to the upright posts. Merchandise gondola suppliers include Lozier Corporation, located at 6336 Pershing Dr. Omaha, Nebr. 68110, and Streater LLC, located at 411 South First Avenue, Albert Lea, Minn. 56007.

Effective retail merchandising requires that merchandise display gondolas located in store aisles be periodically moved to alter store traffic patterns, accommodate new merchandise displays, and generally stimulate customer interest. Most stores do not have the special handling equipment required to move a loaded merchandise gondola. Consequently, it is often necessary to dismantle a display and to move the merchandise and the gondola separately to a new location where the display is reassembled on the gondola.

Conventional gondola/shelf movers operate by lifting the shelving unit off of the ground from the bottom or middle of the shelving unit or by attaching to the top of the shelving unit and raising the unit by rotating conventional scaffolding screws. Bottom lifting movers generally require the removal of merchandise from the shelving unit before moving the unit, which results in a process that is time consuming, labor intensive, and costly. Attaching a scaffolding-like mover to the top of the shelving unit and raising the unit using only conventional scaffolding screws is also time consuming and labor intensive due to the lack of any significant mechanical advantage provided by the conventional scaffolding screws.

U.S. Pat. No. 3,768,676 (hereinafter, “Spitzer”), titled “DESK MOVING DEVICE” issued Oct. 30, 1973, and is incorporated herein by reference. Spitzer describes a load straddling, lifting, handling and transporting device which enables a single user to clampingly harness a heavy office desk, or the like, and move same from a room to facilitate cleaning. It comprises a frame structure having a pair of vertical leg frames whose upper ends are joined by extensible and retractable connecting rails. The lower ends of the legs are provided with casters whereby the respective leg frames serve as rollable trucks. Each leg frame is provided with manually controllable desk engaging lifting and lowering means which serves to accommodate commonly used desks. This device is ideal for classroom use. It enables one man to handle and move the desks while other persons attend to the room cleaning needs.

U.S. Pat. No. 4,275,982 (hereinafter, “Fisco”), titled “APPARATUS FOR MOVING MERCHANDISE GONDOLAS”, issued Jun. 30, 1981, and is incorporated herein by reference. Fisco describe an apparatus for moving merchandise gondolas comprising a collapsible rolling scaffold frame of walk-through type and an adjustable carrying attachment secured to the scaffold frame and adapted for lifting and carrying a merchandise display gondola. A gondola engaged by the carrying attachment may be raised to or lowered from carrying position by manipulating adjustment screws associated with the scaffold casters or with adjustable shoring heads which support the carrying attachment.

U.S. Pat. No. 4,921,264 (hereinafter, “Duffy”), titled “COLLAPSIBLE LIBRARY RANGE DOLLY” issued May 1, 1990, and is incorporated herein by reference. Duffy describes a collapsible library range dolly is formed from a pair of side frame members, a pair of cross members, and a post. The side frame members each have a pair of swivel casters secured to their bottom surface and there are attachment plates secured to their opposite ends. The cross members each have an upright tubular member secured to their top surface adjacent their ends. Bolts that pass through the upright tubular members have their ends secured to the attachment plates of the side frame members. A vertically oriented post is detachably secured to one of the upright tubular members for pushing or pulling the dolly.

U.S. Pat. No. 4,934,893 (hereinafter, “Johnson”), titled “BOOK SHELF MOVING APPARATUS” issued Jun. 19, 1990, and is incorporated herein by reference. Johnson describes a method and apparatus for moving book shelf units. The book shelf units to be moved are of the type having vertical standards generally perpendicular to the ground and having a plurality of vertically spaced slots for supporting horizontal shelves between the standards. The vertical standards of the book shelf units are retainably engaged at positions therealong spaced from the ground. Moving devices are operatively connected to the engaging devices for cooperatively moving the engaging devices in a generally vertical manner relative to the ground. Therefore, movement of the engaging devices when retainably engaged to the vertical book shelf standards lifts and lowers the book shelf. Rolling devices are connected to the moving devices which enable the apparatus to be moved across the ground thereby moving the book shelf unit.

U.S. Pat. No. 5,716,186 (hereinafter, “Jensen et al.”), titled “GONDOLA MOVER AND MOVING METHOD”, issued Feb. 10, 1998, and is incorporated herein by reference. Jensen et al. describe a gondola moving system for moving fully loaded gondolas in lateral or longitudinal directions. The gondola mover includes a plurality of lift assemblies, which can be sequentially connected to one another, depending upon the length of the gondola. Each lift assembly includes a lift arm having a first end extending through the gondola posts, and a second end mounted upon a jack assembly. A base bracket extends between the lift arm and the leg of the gondola. Connecting bars extend between adjacent lift arms. The lift assembly components are quickly and easily assembled and installed upon the gondola without the use of tools.

U.S. Pat. No. 6,460,827 (hereinafter, “Baucom”), titled “PNEUMATIC LIFT AND MOVEMENT SYSTEM FOR SHELVING”, issued Oct. 8, 2002, and is incorporated herein by reference. Baucom describes a lifting and movement system for lifting a complete run of shelving having a plurality of shelf units and for moving the shelving along a floor surface to a desired location. First and second frame structures are defined by interconnected modular frame assemblies so as to have sufficient length to extend along the entire length of a run of shelving. Wheels such as casters are mounted to the first frame to provide for movement of the lifting system and the run of shelving along the floor surface to a desired location. A second, movable frame is in vertically movable assembly with the first frame and has shelving engaging components for lifting engagement with the run of shelving. A plurality of lift elements is supported by the first frame and provide support for the second frame and the shelving engaged thereby. A power system, which is preferably a pneumatic pressure supply is in controllable relation with each of the lift elements and is selectively actuatable for simultaneously activating each of the lift elements for simultaneous lifting or lowering of all of the modular sections of the second frame relative to the first frame to thereby provide for selective lifting or lowering the shelving.

U.S. Pat. No. 7,438,301 (hereinafter, “Schilling et al.”), titled “APPARATUS AND METHODS FOR MOVING STORAGE AND DISPLAY SYSTEMS”, issued Oct. 21, 2008, and is incorporated herein by reference. Schilling et al. describe an apparatus and methods for moving a shelving assembly. The apparatus includes support legs that are connected to the shelving assembly. Jack assemblies are connected to the support legs and are moveable to engage the ground and lift the shelving assembly off the ground. The jack assemblies include wheels so that, when lifted off the ground, the shelving assembly can be moved over the ground with the moving apparatus attached to it.

There is a need for an improved shelf-moving system, particularly improved methods and apparatus for lifting and carrying merchandise gondolas.

### BRIEF SUMMARY OF THE INVENTION

In some embodiments, the present invention provides an apparatus for lifting and moving a merchandise gondola, the apparatus including a plurality of lift units including a first lift unit and a second lift unit, each lift unit including a substantially vertical first member having at least one wheel at a lower end; a substantially vertical second member having at least one wheel at a lower end; a substantially horizontal third member removably connected at a first end to the first member and removably connected at a second end to the second member; a gondola-coupling device centrally located on the third member and configured to couple to a top surface of a merchandise gondola; and a mechanical-lift mechanism operatively coupled to the lift unit and configured to lift the gondola-coupling device in a vertical direction relative to the third member, wherein the mechanical-lift mechanism includes a rotary assembly coupled to the lift unit and configured to provide a two-way mechanically advantaged connection to the gondola-coupling device from the first member and configured to be actuated to lift the gondola-coupling device by a human operator rotating the rotary assembly from just one side of the lift unit while the first member and the second member remain substantially vertical.

In some embodiments, the present invention provides a method for lifting and moving a merchandise gondola, the method including providing a plurality of lift units including a first lift unit and a second lift unit, wherein each lift unit including a substantially vertical first member having at least one wheel at a lower end, a substantially vertical second member having at least one wheel at a lower end, a substantially horizontal third member, a gondola-coupling device centrally located on the third member, and a mechanical lifting mechanism operatively coupled to the lift unit, wherein the mechanical lifting mechanism includes a rotary assembly coupled to the lift unit and configured to provide a two-way mechanically advantaged connection to the gondola-coupling device from the first member and configured to be actuated to lift the gondola-coupling device, the method further including removably connecting a first end of the third member of the first lift unit to the first member of the first lift unit; removably connecting a second end of the third member of the first lift unit to the second member of the first lift unit; attaching a first portion of a top surface of the merchandise gondola to the gondola-coupling device of the first lift unit; and lifting the gondola-coupling device in a vertical direction relative to the third member of the first lift unit using the mechanical lifting mechanism of the first lift unit, wherein the lifting includes rotating the rotary assembly of the first lift unit from just one side of the first lift unit while the first member and the second member of the first lift unit remain substantially vertical.

### BRIEF DESCRIPTION OF THE FIGURES

Each of the items shown in the following brief description of the drawings represents some embodiments of the present invention.

FIG. 1A is an end view of a first end of a gondola-transfer unit 100.

FIG. 1B is an end view of a second end of gondola-transfer unit 100, wherein the second end is opposite the first end.

FIG. 1C is a perspective view of an upper portion of gondola-transfer unit 100.

FIG. 1D is an end view of a first end of lifting mechanism 130 operatively coupled to gondola-transfer unit 100.

FIG. 1E is an end view of a second end of lifting mechanism 130 operatively coupled to gondola-transfer unit 100, wherein the second end is opposite the first end.

FIG. 1F is a top view of lifting mechanism 130 operatively coupled to gondola-transfer unit 100.

FIG. 1G is an end view of an upper portion of gear assembly 140 operatively coupled to gondola-transfer unit 100.

FIG. 1H1 is an end view of a lower portion of gear assembly 140 operatively coupled to gondola-transfer unit 100.

FIG. 1H2 is an end view of a lower portion of a gear assembly 140.1.

FIG. 1i is a side view of the lower portion of gear assembly 140 shown in FIG. 1H1.

FIG. 2A is a perspective view of a plurality of gondola-transfer units 200 operatively coupled together.

FIG. 2B is a top view of three individual gondola-transfer units 201 of the plurality of gondola-transfer units 200 shown in FIG. 2A.

FIG. 2C is a side view of one of the individual gondola-transfer units 201 shown in FIG. 2A.

FIG. 2D is a side view of a bottom portion of the individual gondola-transfer unit 201 shown in FIG. 2C.

FIG. 3 is a diagram of the individual components of a disassembled gondola-transfer unit 300 according to some embodiments of the present invention.

FIG. 4 is an end view of a first end of a gondola-transfer unit 400.

FIG. 5A is an end view of a first end of a gondola-transfer unit 500.

FIG. 5B is an end view of a first end of a gondola-transfer unit 501.

FIG. 6A is a perspective view of a plurality of gondola-transfer units 600 operatively coupled together.

FIG. 6B is a perspective view of a plurality of gondola-transfer units 605 operatively coupled together.

FIG. 7A is a block diagram of a method 700 for assembling a gondola-transfer unit and using the gondola-transfer unit to move a merchandise gondola.

FIG. 7B is a schematic diagram illustrating some of the blocks from method 700 of FIG. 7A.

FIG. 8 is an end view of a fully assembled gondola-transfer unit 800 operatively coupled to a merchandise gondola 99 that has been lifted off of the ground by at least the gondola-transfer unit 800.

### DETAILED DESCRIPTION OF THE INVENTION

Although the following detailed description contains many specifics for the purpose of illustration, a person of ordinary skill in the art will appreciate that many variations and alterations to the following details are within the scope of the invention. Accordingly, the following preferred embodiments of the invention are set forth without any loss of generality to, and without imposing limitations upon the claimed invention.

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

As used herein, a merchandise gondola is a free standing shelving unit used to display products in retail spaces like stores and supermarkets. Merchandise gondolas are different from fixed wall shelving in that a merchandise gondola can be taken apart and moved to suit changing floor plans.

As used herein, a merchandise gondola upright is the vertical portion of a merchandise gondola on which the shelves of the merchandise gondola are attached.

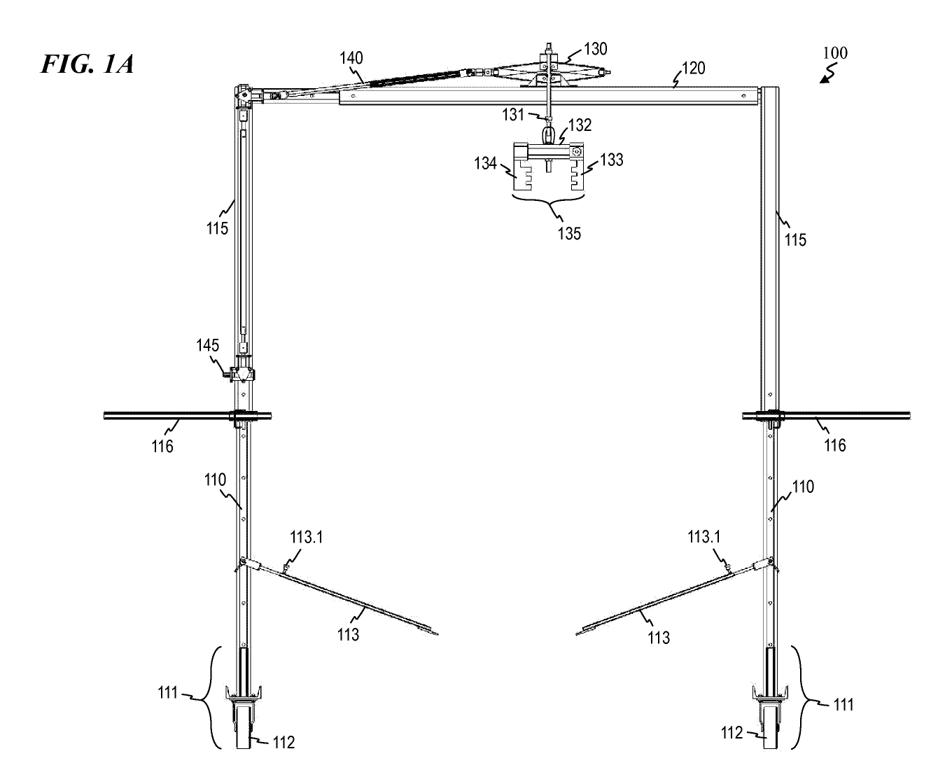

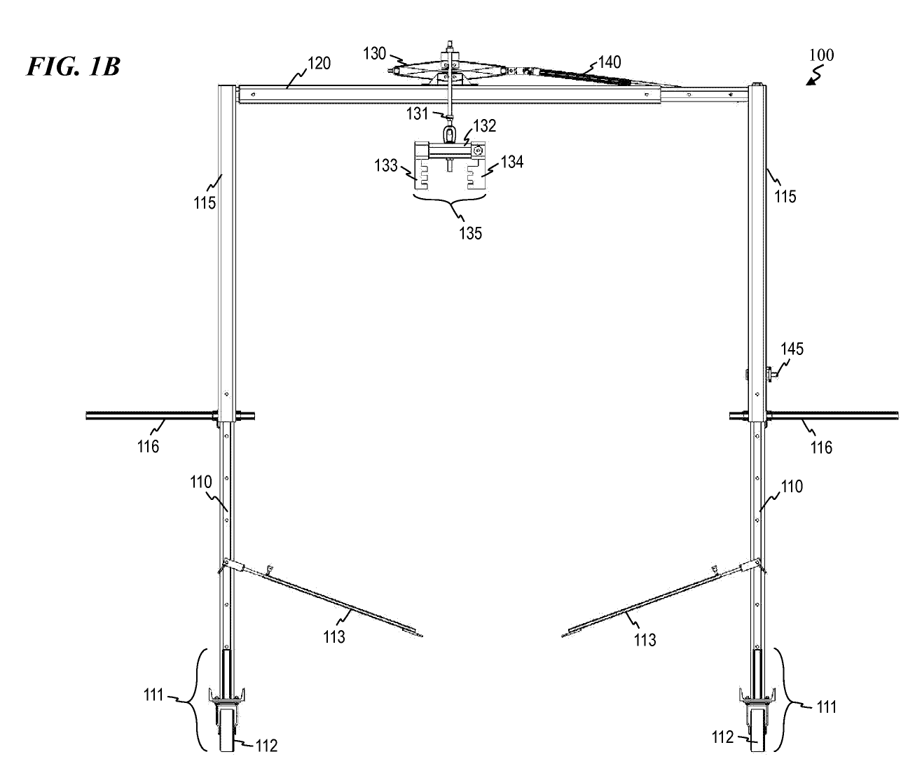

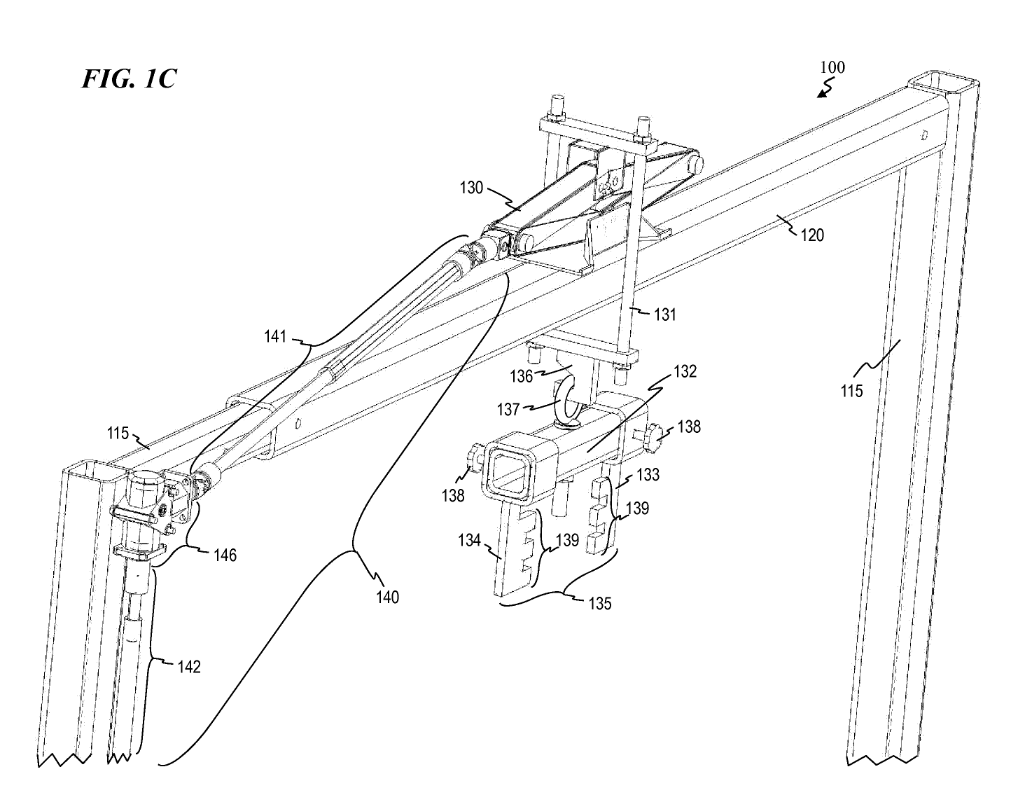

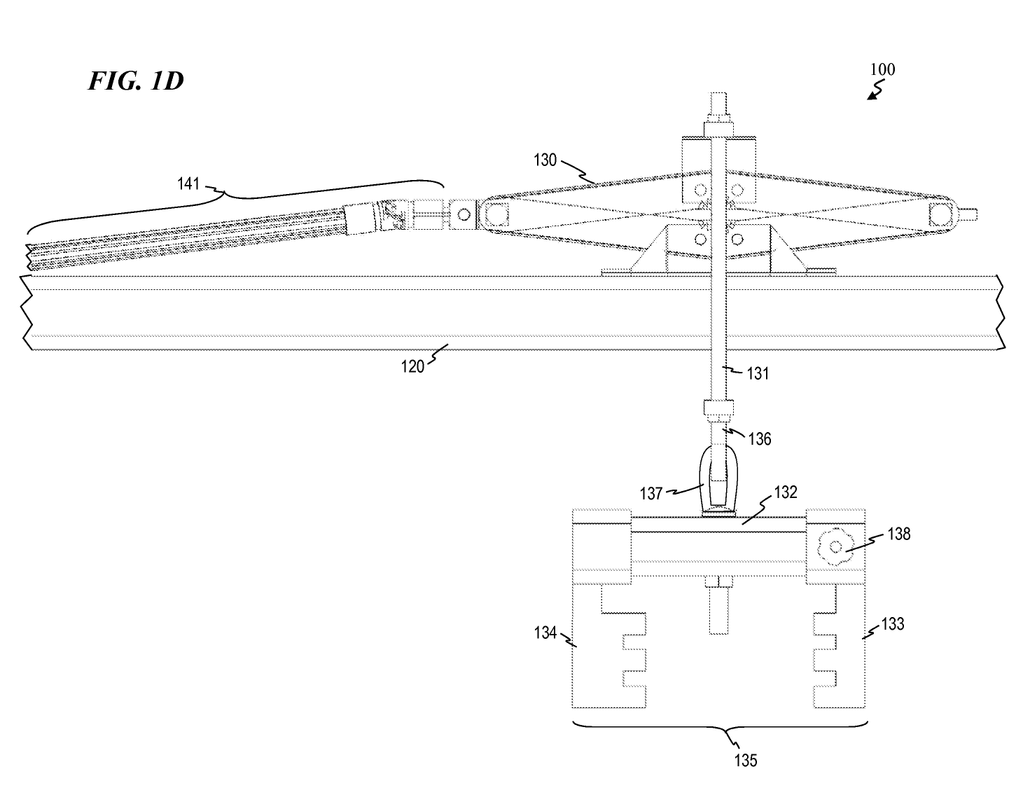

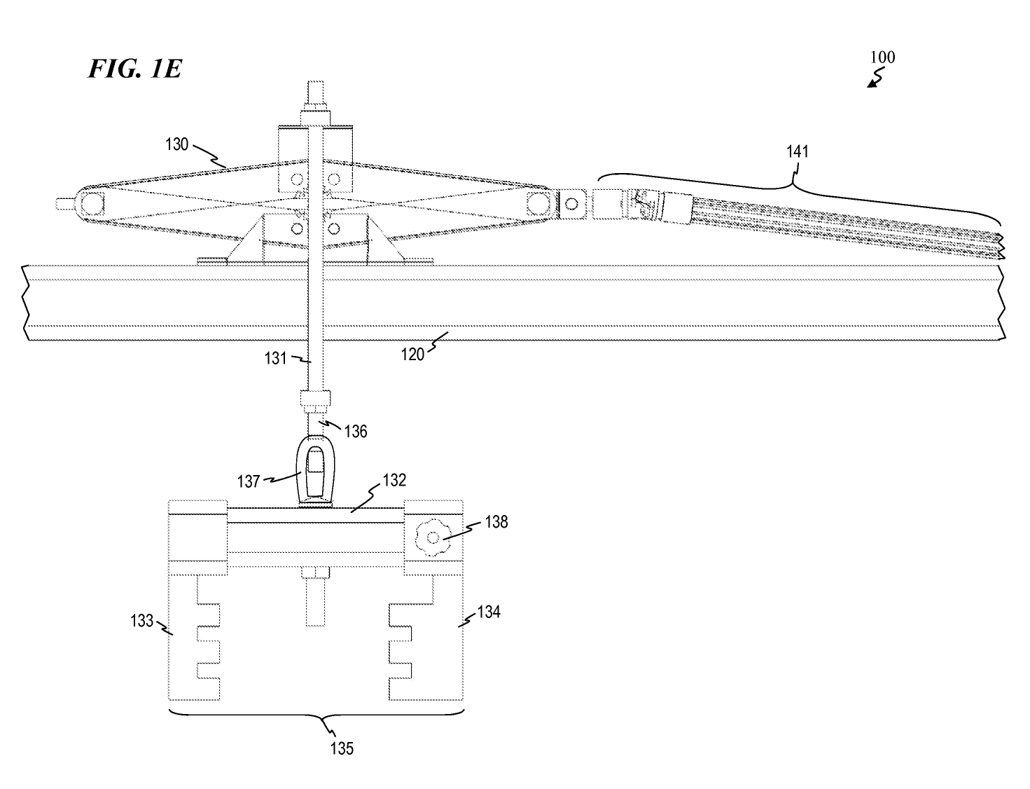

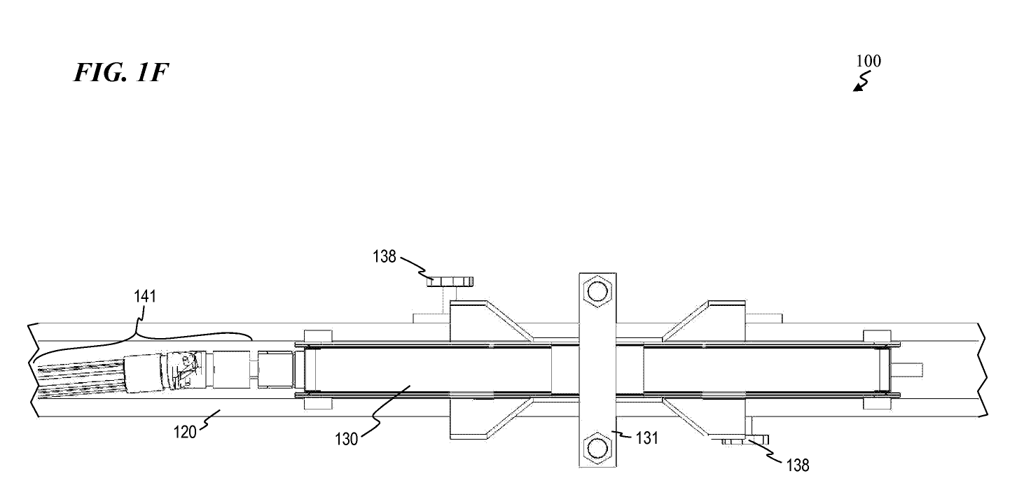

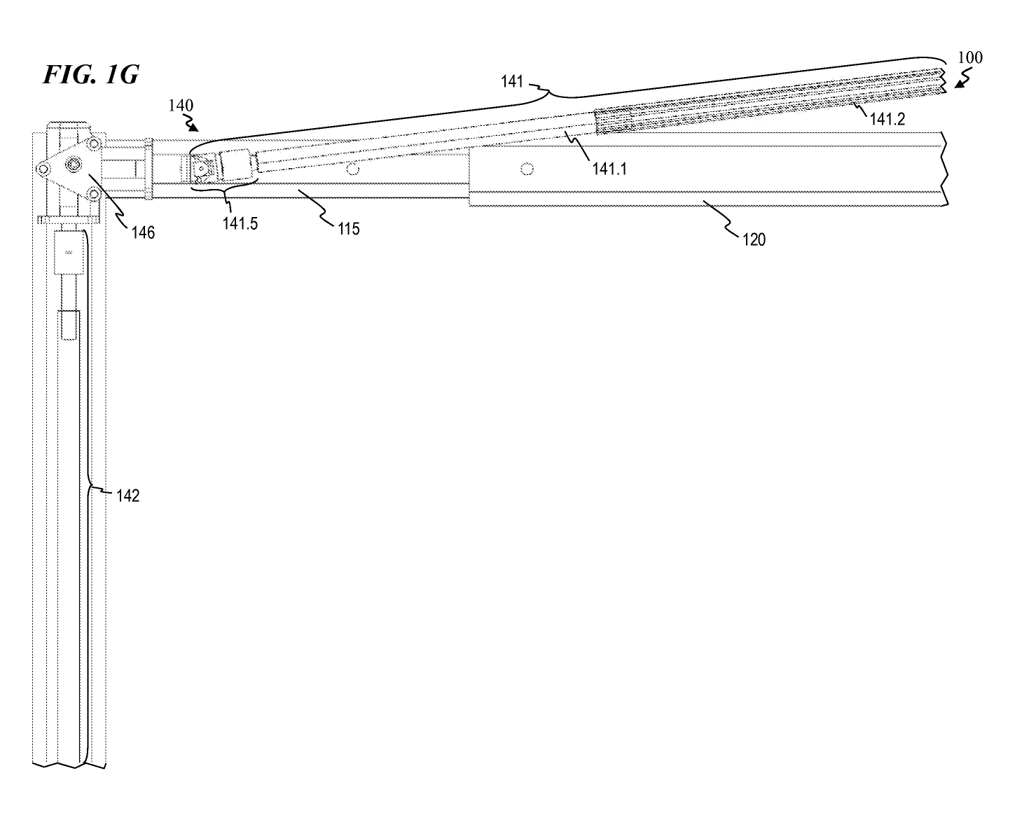

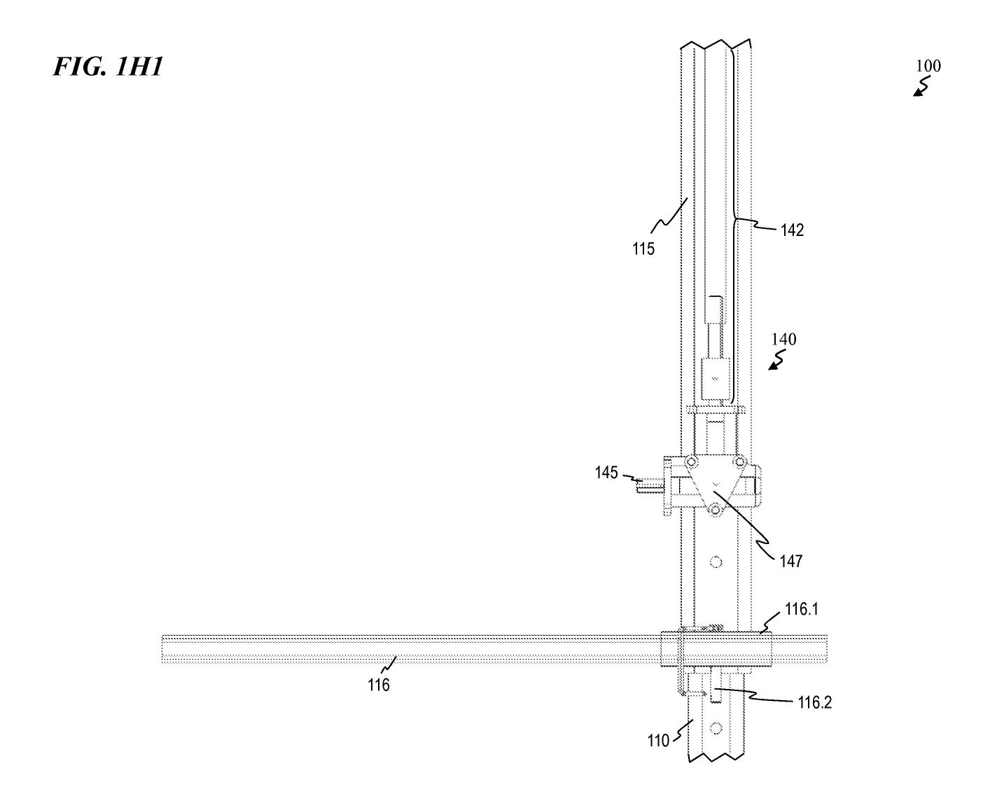

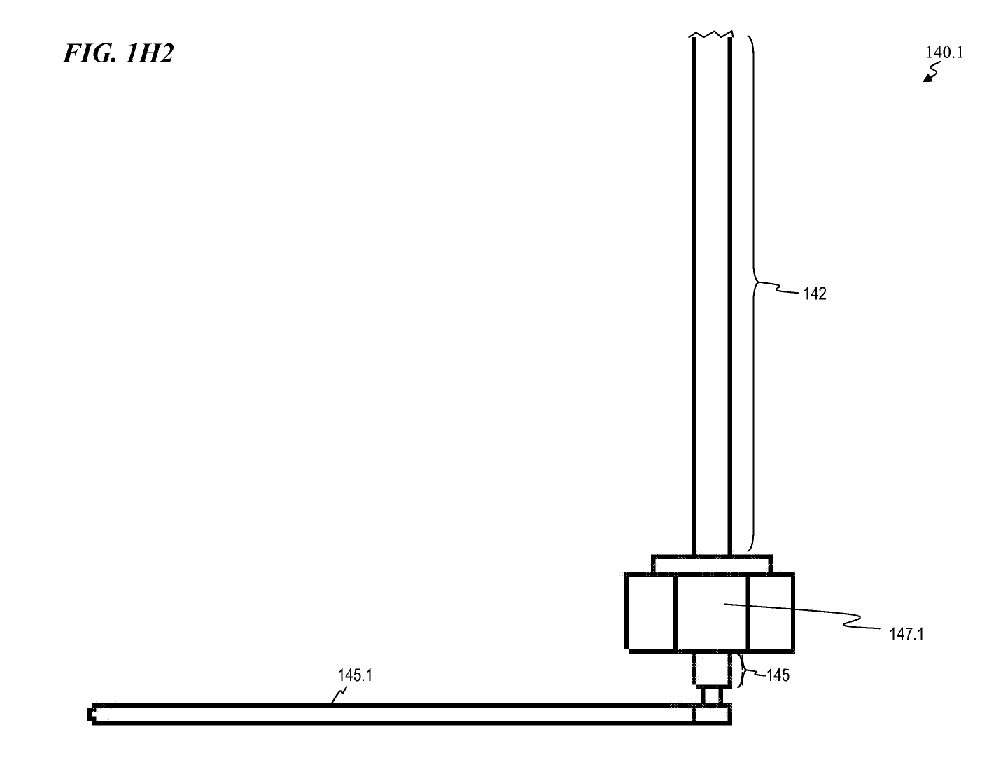

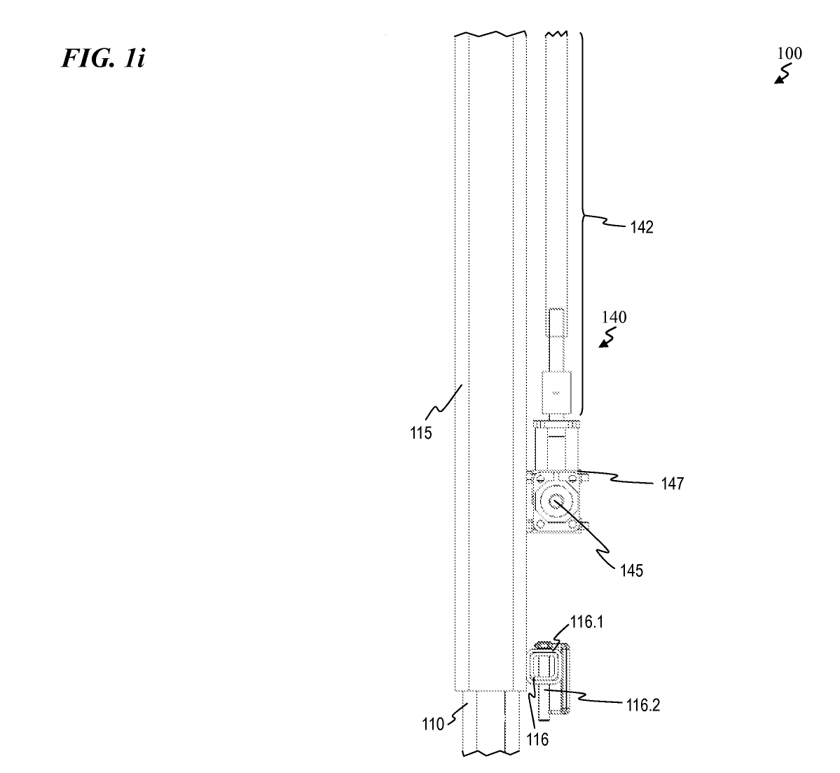

FIG. 1A is an end view of a first end of a gondola-transfer unit 100. In some embodiments, gondola-transfer unit 100 includes two vertical base arms 110, two L-shaped upper arms 115, and a horizontal lift arm 120. In some embodiments, the frame components of gondola-transfer unit 100 including vertical base arms 110, L-shaped upper arms 115, and horizontal lift arm 120 are made from a material that includes steel. In some embodiments, the frame components of gondola-transfer unit 100 are made from a material that includes aluminum, synthetics, rubber, plastics, or any other suitable material. In some embodiments, the frame components of gondola-transfer unit 100 are hollow steel tubes or shafts.

FIG. 1B shows an end view of a second end of gondola-transfer unit 100, wherein the second end is opposite the first end. In some embodiments, vertical base arms 110 provide vertical and lifting support to the gondola during the gondola moving process. In some embodiments, each vertical base arm 110 includes a plurality of height-adjustment hole pairs (i.e., where an individual height-adjustment hole pair includes a first hole on a first side and a second hole on a second opposite side) configured to provide height adjustments for the gondola-transfer unit 110. In some such embodiments, an L-shaped upper arm 115 is placed over the top of a vertical base arm 110 and coupled to the vertical base arm 110 at a desired height by inserting a lock pin (e.g., in some embodiments, a lock pin such as provided by provided by Fastenal Company, 2001 Theurer Blvd., Winona, Minn. 55987) through a pair of height-adjustment slots on the vertical portion of L-shaped upper arm 115 (i.e., where the pair of height-adjustment slots includes a first slot on a first side and a second slot on a second opposite side) and through the desired height-adjustment hole pair on the vertical base arm 110.

In some embodiments, the height of the vertical portion of L-shaped upper arm 115 from the pair of height-adjustment slots to the intersection with the horizontal portion of L-shaped upper arm is about 112 cm, and the height from the ground to the first height-adjustment hole pair on vertical base arm 110 is about 40 cm. In some such embodiments, each vertical base arm 110 includes seven sets of height-adjustment hole pairs that are vertically spaced apart from one another by about 15 centimeters (cm) such that the height of gondola-transfer unit 100 can be increased by a minimum of about 15 cm to a maximum of about 90 cm, and such that when gondola-transfer unit 100 is assembled, the minimum height from the ground to the top of the horizontal lift arm 120 is about 152 cm and the maximum height is about 90 centimeters greater or about 242 cm.

In some embodiments, height-adjustment hole pairs are vertically spaced apart from one another on vertical base arm 110 by about 15 cm. In some embodiments, height-adjustment hole pairs are vertically spaced apart from one another by about 5 cm, by about 10 cm, by about 15 cm, by about 20 cm, by about 30 cm, by about 40 cm, by about 50 cm, or by greater than 50 cm. In some embodiments, height-adjustment hole pairs are vertically spaced apart from one another by less than 5 cm.

In some embodiments, gondola-transfer unit 100 has a minimum height from the ground to the top of horizontal lift arm 120 of about 100 cm, of about 110 cm, of about 120 cm, of about 130 cm, of about 140 cm, of about 150 cm, or of greater than about 150 cm. In some embodiments, gondola-transfer unit 100 has a minimum height from the ground to the top of horizontal lift arm 120 of less than 100 cm. In some embodiments, gondola-transfer unit 100 has a maximum height from the ground to the top of horizontal lift arm 120 of about 200 cm, of about 210 cm, of about 220 cm, of about 230 cm, of about 240 cm, of about 250 cm, of about 300 cm, or of greater than 300 cm. In some embodiments, gondola-transfer unit 100 has a maximum height from the ground to the top of horizontal lift arm 120 of less than 200 cm.

In some embodiments, each vertical base arm 110 includes a base 111 that provides support for vertical base arm 110. In some embodiments, base 111 includes two wheels or casters 112 that are used to roll the gondola-transfer unit 110 from location to location. In some embodiments, each vertical base arm 110 further includes a sway bar 113 configured to stabilize the bottom portion of the merchandise gondola being lifted and moved by gondola-transfer unit 110. In some embodiments, a first end of sway bar 113 is attached to the merchandise gondola by interlocking the first end of sway bar 113 with tabs on the uprights of the merchandise gondola, and a second, opposite end of sway bar 113 is attached to vertical base arm 110 with a U-bracket and threaded bolt and nut. In some embodiments, sway bar 113 includes a first inner tube that fits within a second outer tube such that the first inner tube can be moved in and out of the second outer tube to adjust the width of sway bar 113. In some such embodiments, the width of sway bar 113 is locked into place using a set screw 113.1. In some embodiments, sway bar 113 is made from a material that includes steel. In some embodiments, sway bar 113 is made from a material that includes aluminum, synthetics, rubber, plastics, or any other suitable material.

In some embodiments, gondola-transfer unit 100 includes one or more handles 116 configured to assist in the assembly of the gondola-transfer unit 100 and to provide leverage for moving the assembled gondola-transfer unit 100. In some embodiments, handles 116 are operatively coupled to L-shaped upper arms 115 with a lock pin (in some such embodiments, handle 116 includes a plurality of hole pairs configured to receive the lock pin). In some embodiments, handles 116 are made from a material that includes steel. In some embodiments, handles 116 are made from a material that includes aluminum, synthetics, rubber, plastics, or any other suitable material. In some embodiments, handles 116 are hollow steel tubes or shafts.

In some embodiments, L-shaped upper arm 115 is a hollow steel tube and the vertical portion of L-shaped upper arm 115 has a diameter that is slightly larger than the diameter of a vertical base arm 110 such that the vertical portion of an L-shaped upper arm 115 can slide over the top of a vertical base arm 110 and lock into place at the desired height. In some embodiments, horizontal lift arm 120 is a hollow steel tube and the horizontal portion of L-shaped upper arm 115 has a diameter that is slightly smaller than a diameter of horizontal lift arm 120 such that horizontal lift arm 120 can slide over the horizontal portion of a L-shaped upper arm 115 and lock into place at a desired width. In some embodiments, the horizontal portion of L-shaped upper arm 115 includes a plurality of width-adjustment hole pairs (an individual width-adjustment hole pair includes a first hole on a first side and a second hole on a second opposite side), and in some embodiments, each side of horizontal lift arm 120 is slid over the horizontal portion of a respective L-shaped upper arm 115 and coupled to the respective L-shaped upper arm 115 at a desired width by inserting a lock pin through a pair of width-adjustment slots on each side of horizontal lift arm 120 (i.e., where each pair of width-adjustment slots includes a first slot on a first side and a second slot on a second opposite side) and through the desired width-adjustment hole pair on the respective horizontal portion of L-shaped upper arm 115.

In some embodiments, the width of horizontal lift arm 120 from a first pair of width-adjustment slots on a first end of horizontal lift arm 120 to a second pair of width-adjustment slots on a second end, opposite the first end, is about 142 cm, and the distance from the outside end of L-shaped upper arm 115 to the first width-adjustment hole pair is about 13 cm. In some such embodiments, the horizontal portion of the L-shaped upper arm 115 includes three sets of width-adjustment hole pairs that are horizontally spaced apart from one another by about 15 centimeters (cm) such that the width of gondola-transfer unit 100 can be increased by a minimum of about 15 cm to a maximum of about 30 cm and such that when gondola-transfer unit 100 is assembled, the minimum width of gondola-transfer unit 120 from the outside end of a first L-shaped upper arm 115 to the outside end of a second L-shaped upper arm 115 is about 168 cm and the maximum width is about 228 cm.

In some embodiments, width-adjustment hole pairs are horizontally spaced apart from one another on L-shaped upper arms 115 by about 15 cm. In some embodiments, width-adjustment hole pairs are horizontally spaced apart from one another by about 5 cm, by about 10 cm, by about 15 cm, by about 20 cm, by about 30 cm, by about 40 cm, by about 50 cm, or by greater than 50 cm. In some embodiments, width-adjustment hole pairs are horizontally spaced apart from one another by less than 5 cm.

In some embodiments, gondola-transfer unit 100 has a minimum width from the outside end of a first L-shaped upper arm 115 to the outside end of a second L-shaped upper arm 115 of about 100 cm, of about 110 cm, of about 120 cm, of about 130 cm, of about 140 cm, of about 150 cm, of about 175 cm, of about 200 cm, or of greater than about 200 cm. In some embodiments, gondola-transfer unit 100 has a minimum width from the outside end of a first L-shaped upper arm 115 to the outside end of a second L-shaped upper arm 115 of less than 100 cm. In some embodiments, gondola-transfer unit 100 has a maximum width from the outside end of a first L-shaped upper arm 115 to the outside end of a second L-shaped upper arm 115 of about 200 cm, of about 210 cm, of about 220 cm, of about 230 cm, of about 240 cm, of about 250 cm, of about 300 cm, or of greater than 300 cm. In some embodiments, gondola-transfer unit 100 has a maximum width from the outside end of a first L-shaped upper arm 115 to the outside end of a second L-shaped upper arm 115 of less than 200 cm.

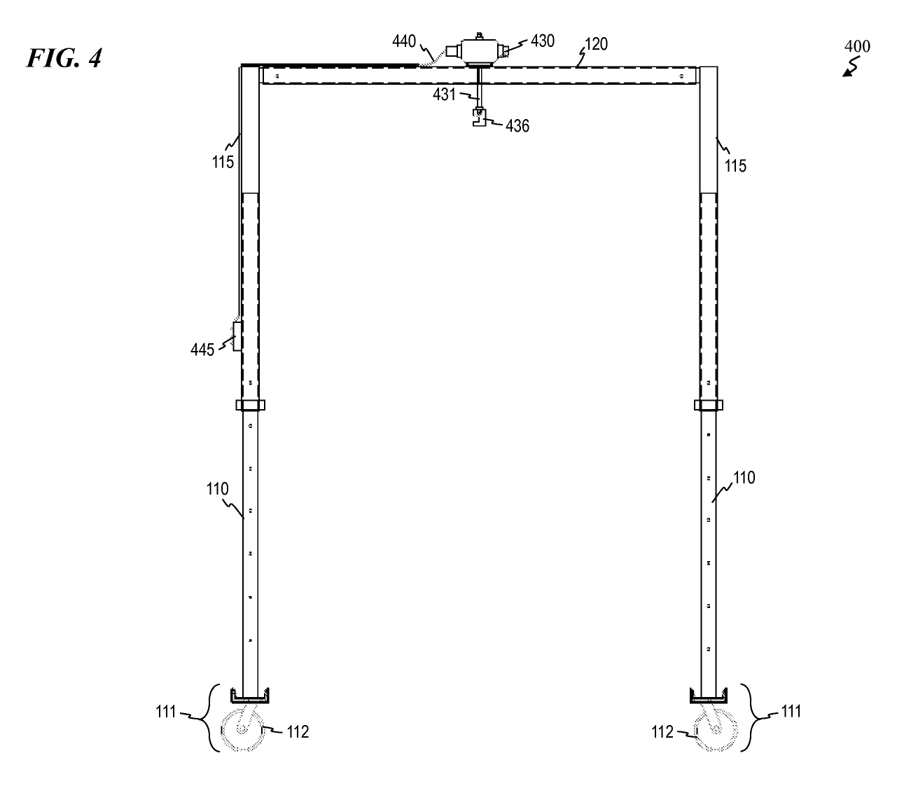

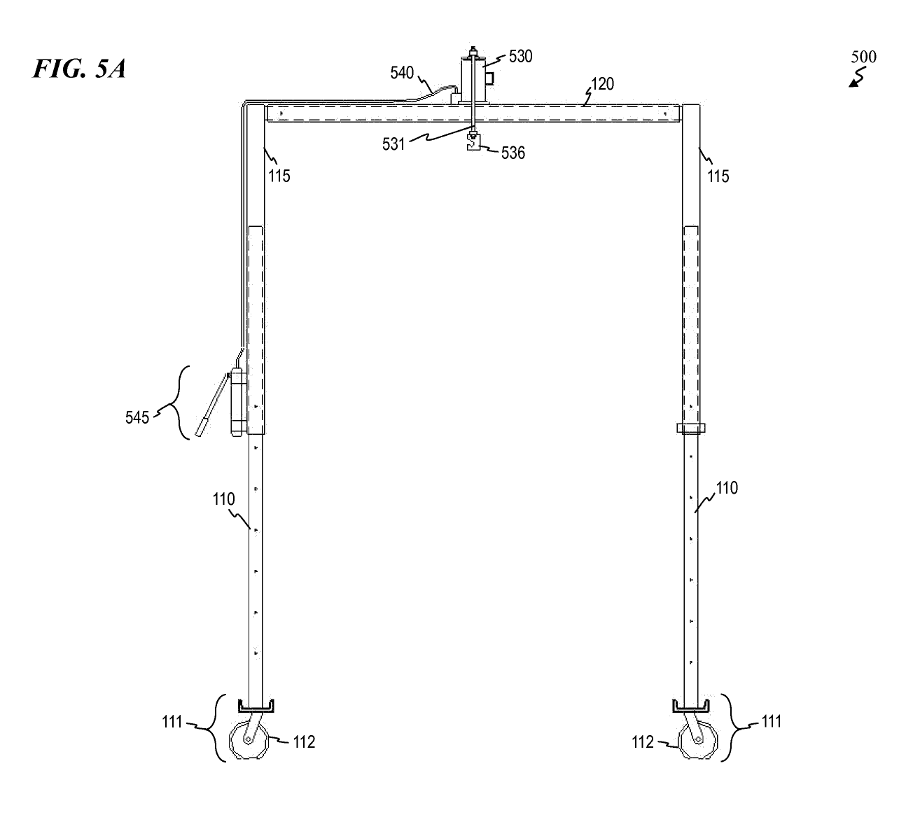

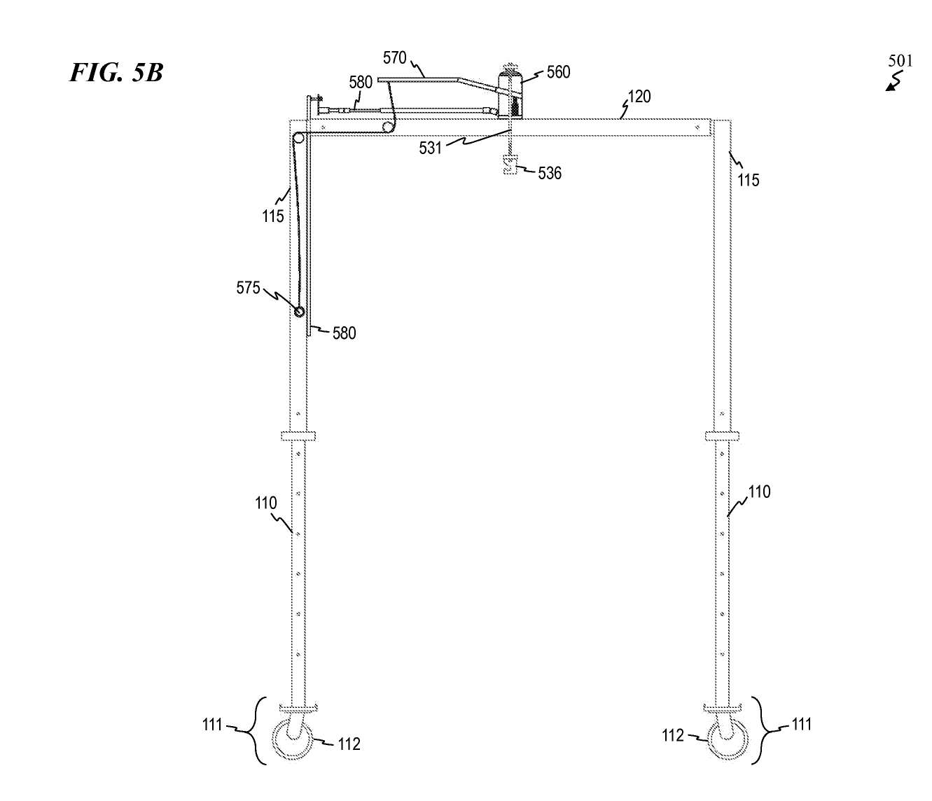

In some embodiments, gondola-transfer unit 100 includes a lifting mechanism 130 configured to provide a lifting force such that a merchandise gondola can be lifted off of the ground from the top portion of the merchandise gondola. In some embodiments, lifting mechanism 130 is welded (or otherwise permanently affixed) to horizontal lift arm 120. In some embodiments, lifting mechanism 130 is removably attached to horizontal lift arm 120 (e.g., in some embodiments, lifting mechanism 130 is bolted to horizontal lift arm 120). In some embodiments, lifting mechanism 130 includes a scissors jack (e.g., in some embodiments, lifting mechanism 130 includes a 1.5 Ton Torin Scissors Jack (Torin Jacks, Inc., 4355 E. Brickell Street, Ontario, Calif., 91761 www.torinjacks.com/ProductDetail.aspx?ProductId=93)), and in some such embodiments, scissors jack 130 is configured to raise lift-hook assembly 131 (and thus raise an attached merchandise gondola off of the ground) in a range from zero cm to about 38 cm. In some embodiments, lifting mechanism 130 includes an electric jack (see FIG. 4). In some embodiments, lifting mechanism 130 includes a hydraulic jack (see FIG. 5A and FIG. 5B). In some embodiments, lifting mechanism 130 includes any other suitable lifting mechanism. In some embodiments, lifting mechanism 130 is operatively coupled to a lift-hook assembly 131 that is raised and lowered by lifting mechanism 130. In some embodiments, the bottom of lift-hook assembly 131 is operatively coupled to the top of a lift bar 132, and in some embodiments, lift bar 132 is operatively coupled to a plurality of lift brackets 135 configured to connect to the top of the merchandise gondola. In some embodiments, lift-hook assembly 131 is made from a material that includes steel. In some embodiments, lift-hook assembly 131 is made from a material that includes aluminum, synthetics, rubber, plastics, or any other suitable material. In some embodiments, lift-hook assembly 131 includes hollow steel tubes or shafts. In some embodiments, lift bar 132 is made from a material that includes steel. In some embodiments, lift bar 132 is made from a material that includes aluminum, synthetics, rubber, plastics, or any other suitable material. In some embodiments, lift bar 132 is a hollow steel tube or shaft. In some embodiments, the plurality of lift brackets 135 is from a material that includes steel. In some embodiments, the plurality of lift brackets 135 is made from a material that includes aluminum, synthetics, rubber, plastics, or any other suitable material. In some embodiments, the plurality of lift brackets 135 includes hollow steel tubes or shafts.

In some embodiments, lifting mechanism 130 is further operatively coupled to a gear-assembly 140 that is configured to provide mechanically advantaged work that operates lifting mechanism 130 such that lift-hook assembly 131 and lift bar 132 can be raised or lowered (and thus a merchandise gondola coupled to lift bar 132 via the plurality of lift brackets 135 can be raised or lowered). In some embodiments, gear-assembly 140 is operatively coupled to a crank device 145. In some embodiments, crank device 145 includes a hand crank that is manually cranked to operate lifting mechanism 130 (via gear-assembly 140) and thus mechanically lift a merchandise gondola attached to gondola-transfer unit 100. In some embodiments, crank device 145 is configured to be coupled to a tool (e.g., in some embodiments, a socket wrench) that can be used to operate gear-assembly 140.

FIG. 1C is a perspective view of an upper portion of gondola-transfer unit 100. In some embodiments, lift-hook assembly 131 includes a four-sided frame with a hook 136 coupled to the bottom side of assembly 131. In some embodiments, the top of the four-sided frame of lift-hook assembly 131 is coupled to the top of lifting mechanism 130 (in some embodiments, the top of the four-sided frame of lift-hook assembly 131 is welded to lifting mechanism 130), and in some embodiments, where lifting mechanism 130 is a scissors jack, the top of lift-hook assembly 131 is pushed up by the expansion of scissors jack 130 such that hook 136 is also raised. In some embodiments, lift-hook assembly 131 includes a four-sided frame where the top side is welded to the top of lifting mechanism 130 and the other three sides are bolted together. In some embodiments, a loop 137 on lift bar 132 is configured to be operatively coupled to hook 136 of lift-hook assembly 131 such that lift bar 132 and the plurality of lift brackets 135 are also raised when scissors jack 130 expands, and thus a merchandise gondola coupled to the plurality of lift brackets 135 is raised off of the ground when scissors jack 130 expands. In some embodiments, loop 137 is attached to lift bar 132 using a threaded bolt and nut. In some embodiments, loop 137 is welded to lift bar 132. In some embodiments, each one of the plurality of lift brackets 135 include a plurality of fingers 139 configured to be inserted into the holes located on the upright of a merchandise gondola such that the merchandise gondola is lifted upwards by raising the plurality of lift brackets 135.

In some embodiments, the plurality of lift brackets 135 includes two standard lift brackets 133 such that a first standard lift bracket 133 is attached to lift bar 132 on a first side of lift bar 132 and a second standard lift bracket 133 is attached to lift bar 132 on a second side of lift bar 132. In some embodiments, the plurality of lift brackets include two end lift brackets 134 such that a first end lift bracket 134 is attached to lift bar 132 on a first side of lift bar 132 and a second end lift bracket 134 is attached to lift bar 132 on a second side of lift bar 132. In FIGS. 1A, 1B, 1C, 1D, and 1E, lift bar 132 is shown as being coupled to a standard lift bracket 133 on one side and an end lift bracket 134 on the other side in order to illustrate the comparative dimensions of end lift bracket 134 and standard lift bracket 133, but in practice, in some embodiments, the lift brackets attached to a given lift bar 132 are either both standard lift brackets 133 or both end lift brackets 134. In some embodiments, end lift brackets 134 are configured to be attached to the ends of a merchandise gondola upright (e.g., in some embodiments, two end lift brackets 134 are coupled to the merchandise gondola upright at a first end of the gondola upright and two end lift brackets 134 are coupled to the gondola upright at a second, opposite end of the gondola upright) and standard lift brackets 133 are configured to be attached to the gondola upright in areas of the upright located between the ends of the gondola upright. In some such embodiments, end lift brackets 134 have larger dimensions than standard lift brackets 133 because, in some embodiments, the ends of a merchandise gondola upright have a different hole dimensions than the holes on the rest of the merchandise gondola upright (e.g., in some embodiments, the plurality of fingers 139 on a standard lift bracket 133 have a width of about 4.5 cm and the plurality of fingers 139 on an end lift bracket 135 have a width of about 6 cm).

In some embodiments, each one of the plurality of lift brackets 135 includes a hollow top portion such that each bracket couples to lift bar 132 by sliding the hollow top portion of the respective lift bracket over a respective side of lift bar 132 and engaging a set screw 138 coupled to the hollow top portion of the respective lift bracket. In some embodiments, each one of the plurality of lift brackets 135 couples to lift bar 132 by sliding the top of the respective lift bracket over a respective side of lift bar 132 and engaging a threaded bolt. In some embodiments, each one of the plurality of lift brackets 135 couple to lift bar 132 in any other suitable manner.

In some embodiments, gear-assembly 140 includes a first gear-assembly arm 141 that operatively connects a first side of lifting mechanism 130 at one end of first gear-assembly arm 141 (e.g. in some embodiments, first gear assembly arm 141 is connected to the first side of lifting mechanism 130 using a universal joint) and operatively connects to a first gear box 146 at a second, opposite end of first arm portion 141 (e.g. in some embodiments, first gear assembly arm 141 is connected to first gear box 146 using a universal joint). In some embodiments, first gear box 146 is coupled to L-shaped upper arm 115 at the junction between the horizontal portion and the vertical portion of L-shaped upper arm 115. In some embodiments, first gear box 146 includes a right-angle gear configuration. In some embodiments, first gear box 146 includes a right-angle worm gear configuration. In some embodiments, first gear box 146 includes any other suitable gear configuration. In some embodiments, first gear box 146 is further operatively coupled to a second gear-assembly arm 142 that runs from first gear box 146 to crank device 145 (in some such embodiments, second gear-assembly arm 142 runs parallel to the vertical portion of L-shaped upper arm 115).

FIG. 1D is an end view of a first end of lifting mechanism 130 operatively coupled to gondola-transfer unit 100.

FIG. 1E is an end view of a second end of lifting mechanism 130 operatively coupled to gondola-transfer unit 100, wherein the second end is opposite the first end.

FIG. 1F is a top view of lifting mechanism 130 operatively coupled to gondola-transfer unit 100.

FIG. 1G is an end view of an upper portion of gear assembly 140 operatively coupled to gondola-transfer unit 100. In some embodiments, first gear-assembly arm 141 includes a first shaft 141.1 having a first diameter and a second shaft 141.2 having a second diameter that is larger than the first diameter such that the length of first gear-assembly arm 141 can be adjusted. In some embodiments, first gear assembly arm 141 includes a universal joint 141.5 configured to connect first gear assembly arm 141 to first gear box 146 (e.g., in some embodiments, universal joint 148 is a universal joint such as provided by Lovejoy, Inc., 2655 Wisconsin Avenue, Downers Grove, Ill. 60515, www.lovejoy-inc.com/products/universal-joints.aspx). In some embodiments, first gear box 146 includes a right-angle gear configuration such as provided by W.C. Branham, Inc., 398 Troy Street, River Falls, Wis. 54022.

FIG. 1H1 is an end view of a lower portion of gear assembly 140 operatively coupled to gondola-transfer unit 100. In some embodiments, second gear-assembly arm 142 runs from first gear box 146 down to a second gear box 147. In some embodiments, second gear box 147 includes a right-angle gear configuration, and in some embodiments, second gear box 147 is operatively coupled to crank device 145. In some embodiments, crank device 145 is configured to coupled to a tool (e.g., in some embodiments, a socket wrench) that can be used to operate gear-assembly 140. In some embodiments, crank device 145 includes a hand crank.

FIG. 1H2 is an end view of a lower portion of a gear assembly 140.1. In some embodiments, gear assembly 140.1 is interchangeable with gear assembly 140 such that gear assembly 140.1 is configured to be operatively coupled to gondola-transfer unit 100 (not shown in FIG. 1H2). In some embodiments, gear assembly 140.1 is substantially similar to gear assembly 140 except that second gear-assembly arm 142 is coupled directly to crank device 145 such that crank device 145 points straight down from second gear-assembly arm 142 in a direction parallel to vertical base arm 110 of gondola-transfer unit 100. In some such embodiments, there is no second gear box 147 and gear assembly 140.1 further includes a pillow block 147.1 coupled to vertical base arm 110 of gondola-transfer unit 100 and configured to guide gear-assembly arm 142 from gear box 146 (not shown in FIG. 1H2) to crank device 145 (e.g., in some embodiments, the pillow block is provided by The Big Bearing Store, a Carnell Sales dba, 157 S. Parkway E., Memphis, Tenn. 38106). In some embodiments, a tool 145.1 (e.g., a socket wrench) is operatively coupled to crank device 145 and is configured to be manually turned to operate lifting mechanism 130 (via gear-assembly 140.1) and thus mechanically lift a merchandise gondola attached to gondola-transfer unit 100.

FIG. 1i is a side view of the lower portion of gear assembly 140 shown in FIG. 1H1.

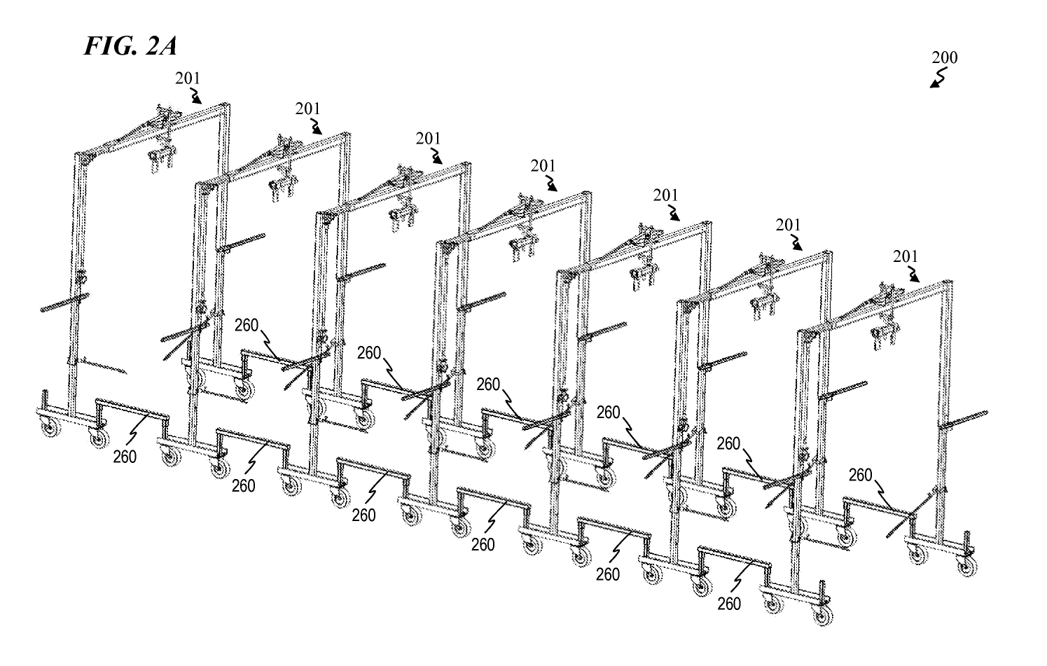

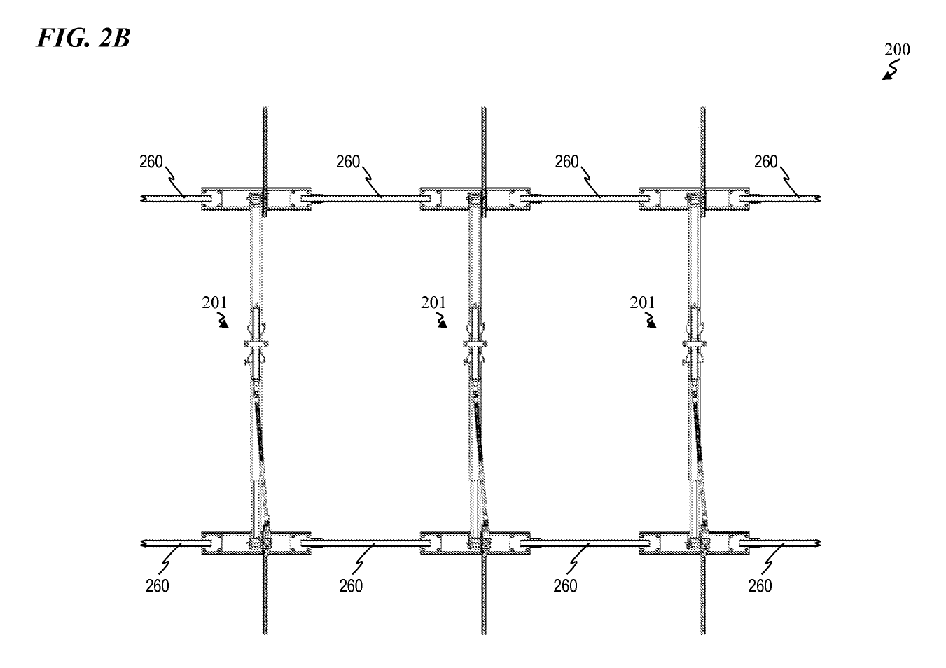

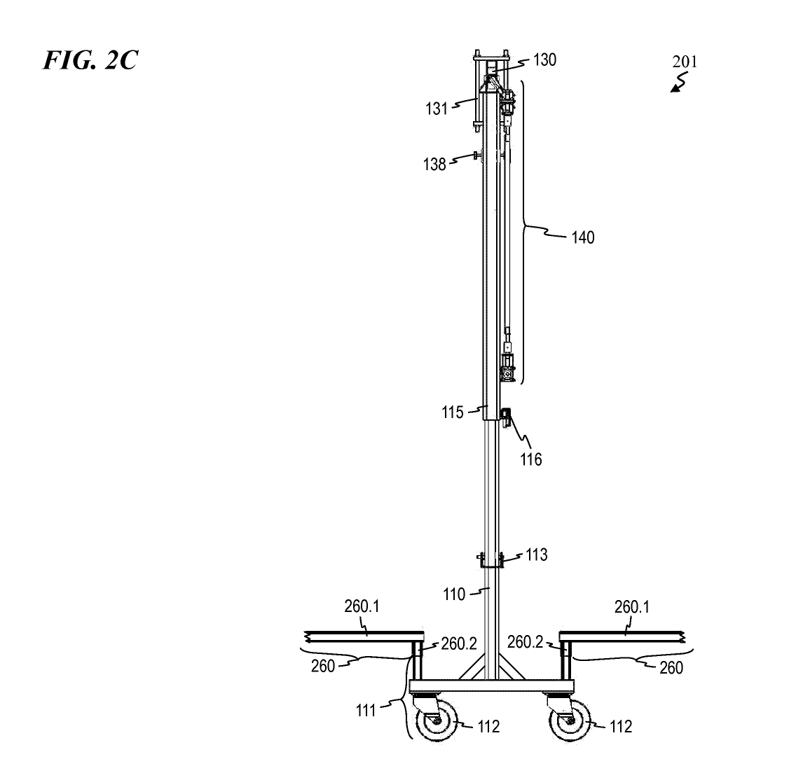

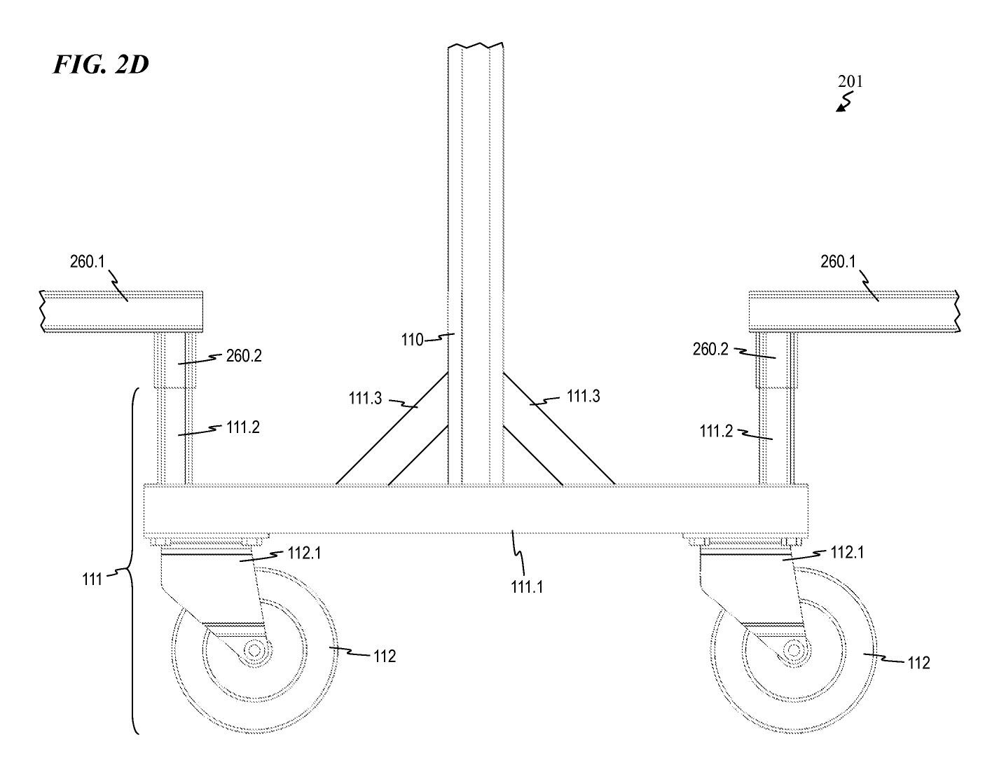

FIG. 2A is a perspective view of a plurality of gondola-transfer units 200 operatively coupled together. In some embodiments, the plurality of gondola-transfer units 200 are coupled together in order to lift and move a single merchandise gondola, and in some such embodiments, each one of the plurality of gondola-transfer units 201 is coupled to a different portion of the merchandise gondola upright to be lifted. In some embodiments, each one of the plurality of gondola-transfer units 201 is substantially similar to gondola-transfer unit 100 described above. In some embodiments, an individual gondola-transfer unit 201 is operatively coupled to an adjacent gondola-transfer unit 201 using at least one spreader bar 260. In some embodiments, the plurality of gondola-transfer units 200 includes seven individual gondola-transfer units 201 operatively coupled together. In other embodiments, the plurality of gondola-transfer units 200 includes any other suitable number of individual gondola-transfer units 201 operatively coupled together.

In some embodiments, a first individual gondola-transfer unit 201 is operatively coupled to at least a second adjacent gondola-transfer unit 201 using two spreader bars 260, and in some such embodiments, a first spreader bar 260 couples the adjacent gondola-transfer units 201 on a first side of the two gondola-transfer units 201, and a second spreader bar 260 connects the two adjacent gondola-transfer units 201 on a second side of the two gondola-transfer units 201. In some embodiments, spreader bar 260 is configured to provide horizontal spacing and support to the plurality of gondola-transfer units 200.

FIG. 2B is a top view of three individual gondola-transfer units 201 of the plurality of gondola-transfer units 200 shown in FIG. 2A.

FIG. 2C is a side view of one of the individual gondola-transfer units 201 shown in FIG. 2A. In some embodiments, spreader bar 260 includes a horizontal portion 260.1 and two vertical portions 260.2 jutting downward (i.e., toward the ground) from the horizontal portion 260.1. In some embodiments, vertical portions 260.2 are welded to horizontal portion 260.1. In some embodiments, vertical portions 260.2 are connected to horizontal portion 260.1 in any other suitable manner. In some embodiments, spreader bar 260 is made from a material that includes steel. In some embodiments, spreader bar 260 is made from a material that includes aluminum, synthetics, rubber, plastics, or any other suitable material. In some embodiments, spreader bar 260 is a hollow steel tube or shaft.

FIG. 2D is a side view of a bottom portion of the individual gondola-transfer unit 201 shown in FIG. 2C. In some embodiments, base 111 of vertical base arm 110 includes a platform 111.1, and a plurality of vertical posts 111.2 (in some embodiments, two vertical posts 111.2). In some embodiments, a plurality of angled gussets 111.3 coupled (e.g., welded) between vertical base arm 110 and platform 111.1 provide additional support to vertical base arm 110. In some embodiments, vertical portion 260.2 of spreader bar 260 is a hollow tube and has a diameter that is slightly larger than the diameter of vertical post 111.2 such that spreader bar 260 is coupled to base 111 by sliding vertical portion 260 over vertical posts 111.2. In some embodiments, the components of base 111 are made from a material that includes steel. In some embodiments, the components of base 111 are made from a material that includes aluminum, synthetics, rubber, plastics, or any other suitable material. In some embodiments, wheels or casters 112 are coupled to platform 111.1 using a wheel support 112.1. In some embodiments, wheel support 112.1 is removably coupled to platform 111.1 (e.g., bolted). In some embodiments, wheel support 112.1 is permanently coupled to platform 111.1 (e.g., welded). In some embodiments, wheel support 112.1 includes a swivel joint such that the wheel 112 coupled to wheel support 112.1 can rotate or swivel. In other embodiments, wheel support 112.1 includes a stationary joint such that the wheel 112 coupled to wheel support 112.1 cannot rotate or swivel. In some embodiments, wheels 112 and wheel supports 112.1 are provided by a supplier such as Caster City, Inc., 8635 Bright Angel Way, Las Vegas, Nev. 89149, www.castercity.com/products.htm. In some embodiments, wheels 112 are made from a material that includes steel, aluminum, synthetics, rubber, plastics, or any other suitable material.

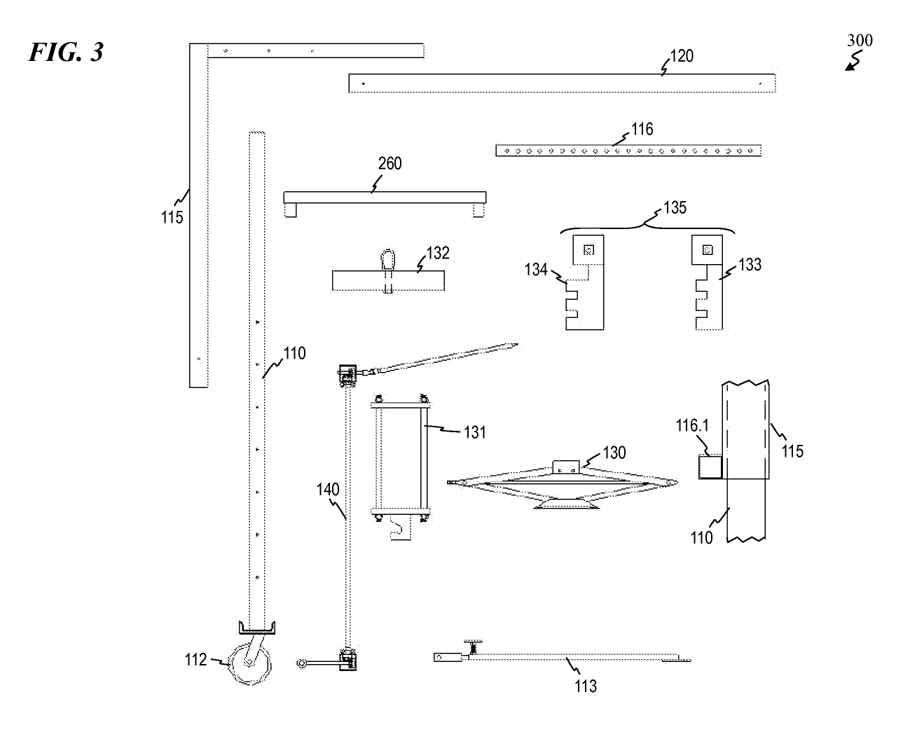

FIG. 3 is a diagram of the individual components of a disassembled gondola-transfer unit 300 according to some embodiments of the present invention. In some embodiments, gondola-transfer unit 300 is substantially similar to gondola-transfer unit 201 and/or gondola-transfer unit 100 described above. In some embodiments, gondola-transfer unit 300 includes two vertical base arms 110 (each vertical base arm 110 including two wheels 112), two sway bars 113, two L-shaped upper arms 115 (each L-shaped upper arm 115 including a sleeve 116.1), two handles 116, a horizontal lift arm 120, a lifting mechanism 130, a lift-hook assembly 131, a lift bar 132, a plurality of lift brackets 135 (including two standard lift brackets 133 or two end lift brackets 134), and a gear assembly 140. In some embodiments, a first gondola-transfer unit 300 is coupled to a second gondola-transfer unit 300 using two spreader bars 260.

FIG. 4 is an end view of a first end of a gondola-transfer unit 400. In some embodiments, gondola-transfer unit 400 is substantially similar to gondola-transfer unit 100 except that lifting mechanism 130, lift-hook assembly 131, hook 136, gear assembly 140, and crank device 145 are replaced with electric lifting mechanism 430, lift shaft 431, hook 436, electric wiring 440, and electric control device 445. In some embodiments, electric lifting mechanism 430 includes a power cord that plugs into a standard 110 V wall outlet to provide power for electric lifting mechanism 430. In some embodiments, electric lifting mechanism 430 includes one or more self-contained batteries that provide power for electric lifting mechanism 430 (in some such embodiments, the self-contained batteries are rechargeable and electric lifting mechanism 430 includes a power cord that plugs into a standard 110 V wall outlet to provide power to recharge the batteries). In some embodiments, electric wiring 440 electrically connects electric lifting mechanism 430 to control device 445 (e.g., an electric switch) such that control device 445 is configured to control the operation of electric lifting mechanism 430. In some embodiments, electric lifting mechanism 430 includes an electric hoist (e.g., an electric hoist such as provided by Northern Tool & Equipment, 2800 Southcross Drive West, Burnsville, Minn., 55306).

FIG. 5A is an end view of a first end of a gondola-transfer unit 500. In some embodiments, gondola-transfer unit 500 is substantially similar to gondola-transfer unit 100 except that lifting mechanism 130, lift-hook assembly 131, hook 136, gear assembly 140, and crank device 145 are replaced with hydraulic lifting mechanism 530, lift shaft 531, hook 536, hydraulic line 540, and hydraulic pump 545 (e.g., in some embodiments, hydraulic lifting mechanism 530 is a Torin 1.5 Ton Hydraulic Scissors Jack from Torin Jacks, Inc., 4355 E. Brickell Street, Ontario, Calif. 91761). In some embodiments, hydraulic pump 545 is configured to create highly-pressurized hydraulic fluid in hydraulic line 540 that is transferred into hydraulic lifting mechanism 530 (e.g., a hydraulic cylinder) in order to create the force necessary to raise lift shaft 531 and hook 536 and thus raise a merchandise gondola attached to gondola-transfer unit 500 via hook 536 and a lift bar 132 (such as shown in FIG. 3). In some embodiments, hydraulic pump 545 is a hand-operated pump. In other embodiments, hydraulic pump 545 is any other suitable hydraulic pump (e.g., an electric pump).

FIG. 5B is an end view of a first end of a gondola-transfer unit 501. In some embodiments, gondola-transfer unit 501 is substantially similar to gondola-transfer unit 500 except that hydraulic lifting mechanism 530, hydraulic line 540, and hydraulic pump 545 are replaced with hydraulic lifting mechanism 560. In some embodiments, hydraulic lifting mechanism 560 includes a self-contained hydraulic jack (i.e., in some embodiments, there are no external hydraulic lines connected to hydraulic lifting mechanism 560). In some embodiments, hydraulic fluid contained within lifting mechanism 560 is pressurized (and thus lift shaft 531 and hook 536 are raised) by repeatedly pulling down on lever mechanism 570, which is operated by pulling on cable system 575. In some embodiments, lever mechanism 570 is spring loaded such that lever mechanism 570 automatically releases back to a starting position after being pulled down by cable system 575. In some embodiments, hydraulic lifting mechanism 560 includes a shaft-and-lever system 580 configured to open a port on hydraulic lifting mechanism 560 and release hydraulic-fluid pressure such that lift shaft 531 and hook 536 are lowered. In some embodiments, shaft-and-lever system 580 includes a vertical portion that runs parallel to the vertical portion of L-shaped upper arm 115 and a horizontal portion that runs parallel to horizontal lift arm 120. In some embodiments, shaft-and-lever system 580 is operated by pulling down on the vertical portion of shaft-and-lever system 580. In some such embodiments, shaft-and-lever system 580 is spring loaded such that the default configuration of shaft-and-lever system 580 does not release any hydraulic-fluid pressure that may be built up in hydraulic lifting mechanism 560.

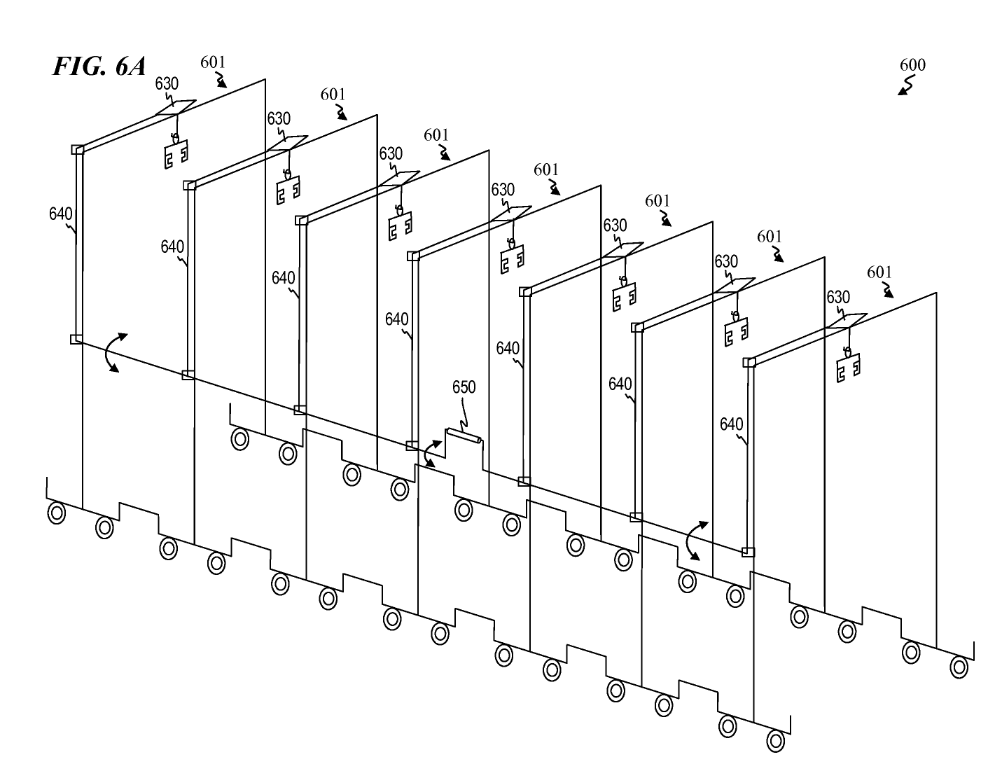

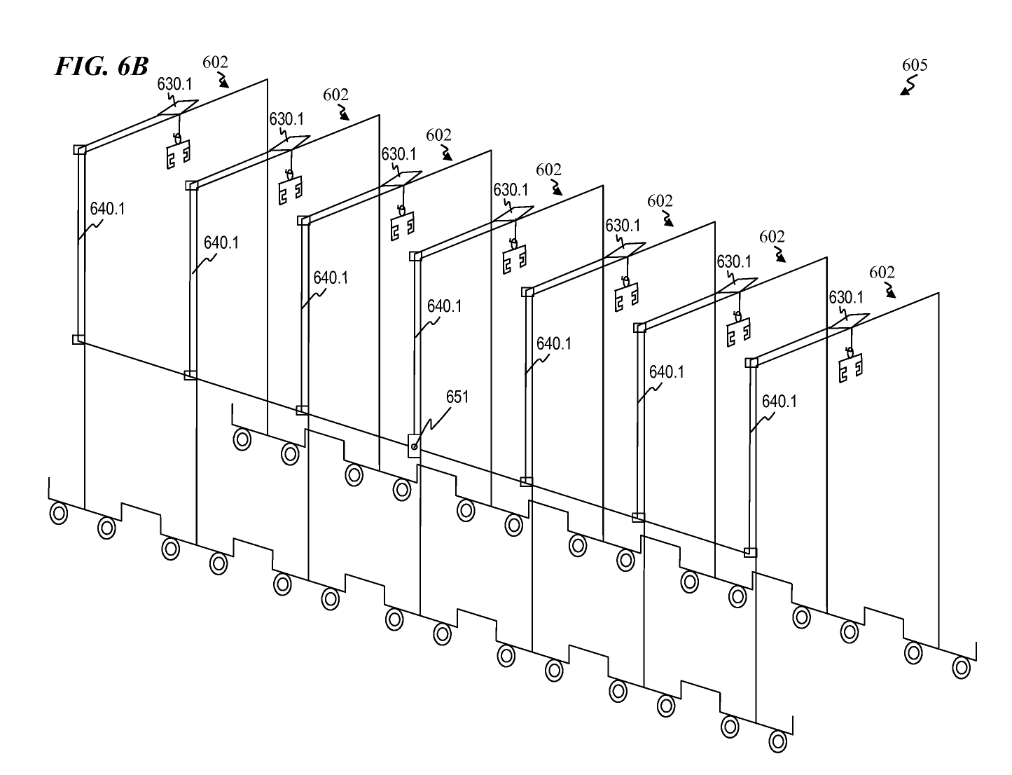

FIG. 6A is a perspective view of a plurality of gondola-transfer units 600 operatively coupled together. In some embodiments, each individual gondola-transfer unit 601 is substantially similar to gondola-transfer unit 100 discussed above. In some embodiments, each gondola-transfer unit 601 includes a lifting mechanism 630 and all of the lifting mechanisms 630 are controlled by a single control device 650 such that all of the lifting mechanisms 630 are configured to lift simultaneously and at substantially the same rate (and thus a merchandise gondola coupled to the plurality of gondola-transfer units 600 is lifted evenly across the gondola). In some embodiments, control device 650 is configured to manually operate all of the lifting mechanisms 630 (e.g., in some such embodiments, control device 650 is a hand crank mechanically coupled to each respective gear assembly 640, and each gear-assembly 640 includes two gear boxes configured to provide mechanically advantaged work (generated by rotating hand crank 650) that operates a respective lifting mechanism 630 (e.g., a scissors jack)).

FIG. 6B is a perspective view of a plurality of gondola-transfer units 605 operatively coupled together. In some embodiments, each individual gondola-transfer unit 602 is substantially similar to gondola-transfer unit 100 discussed above. In some embodiments, each gondola-transfer unit 602 includes a lifting mechanism 630.1 and all of the lifting mechanisms 630.1 are controlled by a single control device 651 such that all of the lifting mechanisms 630.1 are configured to lift simultaneously and at substantially the same rate (and thus a merchandise gondola coupled to the plurality of gondola-transfer units 605 is lifted evenly across the gondola). In some embodiments, control device 651 is configured to electrically control the operation of all of the lifting mechanisms 630.1 (e.g., in some embodiments, control device 651 is an electric control switch, each one of the lifting mechanisms 630.1 is an electric lifting mechanism, and control switch 651 is electrically connected to each lifting mechanism 630.1 via electric wiring 640.1). In other embodiments, control device 651 is configured to hydraulically control the operation of all of the lifting mechanisms 630.1 (e.g., in some embodiments, control device 651 is a hydraulic control switch, each one of the lifting mechanisms 630.1 is a hydraulic lifting mechanism, and hydraulic control switch 651 is operatively coupled to each lifting mechanism 630.1 via hydraulic lines 640.1).

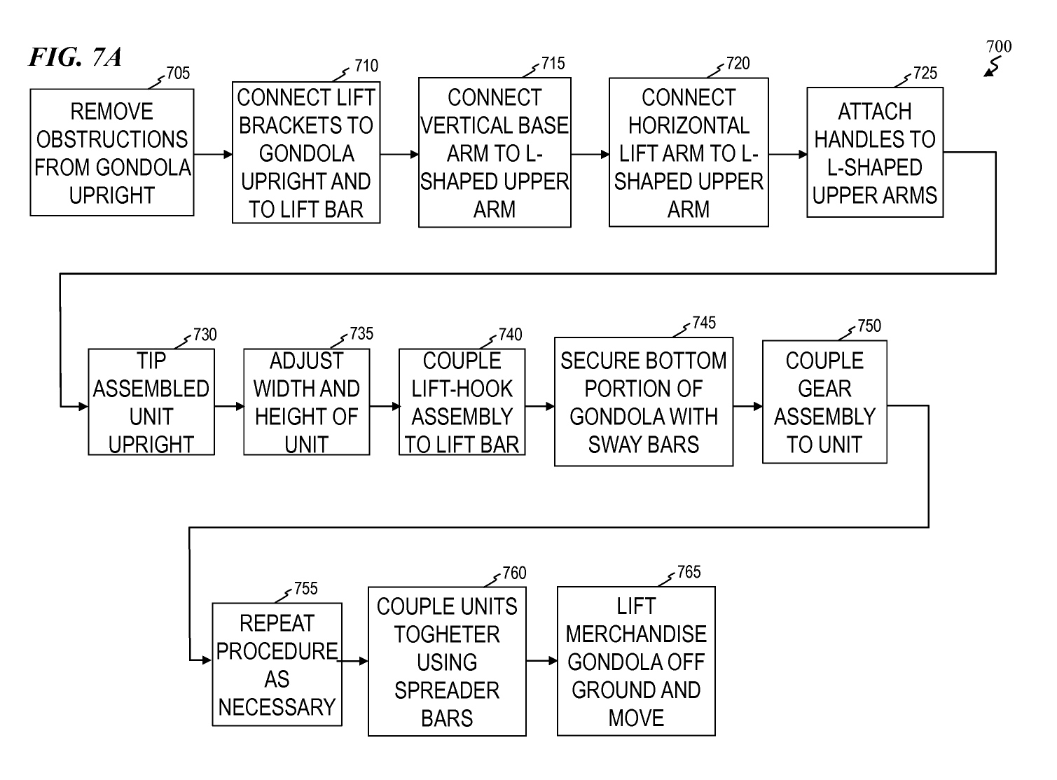

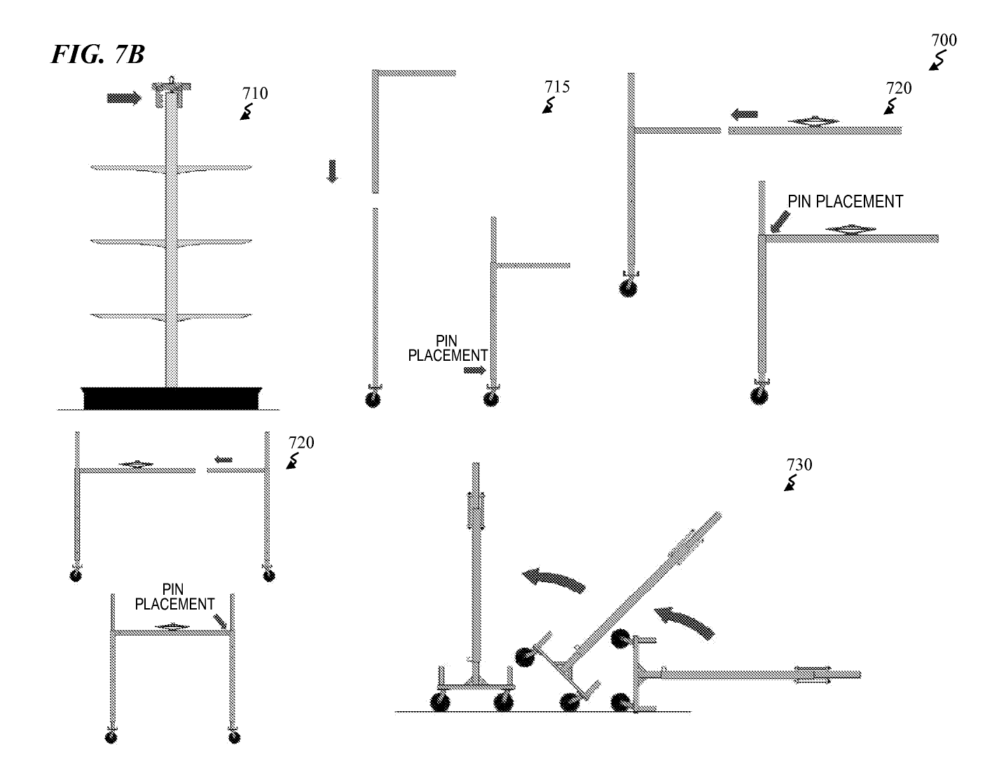

FIG. 7A is a block diagram of a method 700 for assembling a gondola-transfer unit and using the gondola-transfer unit to move a merchandise gondola. In some embodiments, the merchandise gondola has a length of about 7.32 meters (i.e., 24 feet), a height of about 2.13 meters (i.e., 7 feet), and a width of about 1.27 meters (i.e., 4⅙ feet). In some embodiments, the gondola transfer unit assembled according to method 700 is substantially similar to gondola-transfer unit 100 discussed above. In some embodiments, at block 705, obstructions (e.g., signage or any other objects that will interfere with the holes on the merchandise gondola upright) are removed from the upright of the merchandise gondola, and the merchandise on the merchandise gondola is checked to make sure that no items are subject to fall during the move of the merchandise gondola.

In some embodiments, at block 710, a first lift bracket (e.g., a standard lift bracket 133) is slid over a first side of a lift bar (e.g., lift bar 132), and the plurality of fingers of the first lift bracket are coupled to a first side of the merchandise-gondola upright by interlocking the plurality of fingers on the first lift bracket with corresponding holes on the first side of the merchandise gondola upright. After coupling the first lift bracket to the first side of the merchandise-gondola upright, the first lift bracket is secured to the lift bar using a set screw. In some embodiments, also at block 710, a second lift bracket (e.g., a standard lift bracket 133), is slid over a second side of the lift bar. The second lift bracket is then coupled to a second side the merchandise-gondola upright by interlocking the plurality of fingers on the second lift bracket with corresponding holes on the second side of the merchandise-gondola upright. After coupling the second lift bracket to the second side of the merchandise-gondola upright, the second lift bracket is secured to the lift bar using a set screw.

In some embodiments, at block 715, a first vertical base arm (e.g., vertical base arm 110) is coupled to a first L-shaped upper arm (e.g., L-shaped upper arm 115) by sliding the vertical portion of the first L-shaped upper arm over the first vertical base arm and securing the L-shaped upper arm to the vertical base arm by inserting and securing a lock pin at the lowest height-adjustment hole pair on the vertical base arm (i.e., the hole pair closest to the base of the vertical base arm; see FIG. 7B). A second vertical base arm is then coupled to a second L-shaped upper arm in a similar manner.

In some embodiments, at block 720, the two L-shaped upper arm/vertical base arm pairs are coupled together using a horizontal lift arm (e.g., horizontal lift arm 120). In some embodiments, a lifting mechanism (e.g., lifting mechanism 130) with a lift-hook assembly (e.g., lift-hook assembly 131) attached to the lifting mechanism is coupled to the horizontal lift arm before coupling the horizontal lift arm to the two L-shaped upper arm/vertical base arm pairs. In some embodiments, a first side of a horizontal lift arm is slid over the horizontal portion of the first L-shaped upper arm and secured to horizontal portion of the first L-shaped upper arm by inserting and securing a lock pin at a width-adjustment hole pair on the horizontal portion of the first L-shaped upper arm (e.g., in some embodiments, a lock pin is inserted at the width-adjustment hole pair closest to the ninety-degree bend of the first L-shaped upper arm; see FIG. 7B). The coupling of the two L-shaped upper arm/vertical base arm pairs together is completed by coupling the second, opposite, side of the horizontal lift arm to the second L-shaped upper arm in a similar manner. The L-shaped upper arm/vertical base arm pairs coupled together with the horizontal lift arm forms the frame of a gondola-transfer unit according to some embodiments of the present invention.

In some embodiments, at block 725, a handle (e.g., handle 116) is attached to each side of the frame of the gondola-transfer unit. In some embodiments, a first handle is slid into the sleeve (e.g., sleeve 116.1) of the first L-shaped upper arm and secured with a lock pin (e.g., lock pin 116.2), and a second handle is slid into the sleeve of the second L-shaped upper arm and secured with a lock pin.

In some embodiments, at block 730 the frame is carefully brought upright using the handles after ensuring all of the lock pins are securely in place. In some embodiments, at block 735, the width and height of the frame are adjusted such that the frame can straddle the merchandise gondola. In some embodiments, at block 740, the hook of the lift-hook assembly is coupled to the loop of the lift bar that is already coupled to the merchandise-gondola upright (in some such embodiments, the width and height are further adjusted to make this connection). In some embodiments, the lifting mechanism is a scissors jack and in some such embodiments, the scissors jack is expanded by about 13 centimeters (i.e., about 5 inches) before coupling the lift-hook assembly to the loop of the lift bar in order to provide sufficient lifting capacity to lift the merchandise gondola. In some embodiments, at block 745, the bottom portion of the merchandise gondola is secured by coupling a sway bar (e.g., sway bar 113) to each side of the bottom portion of the merchandise gondola. In some embodiments, at block 750, a gear assembly (e.g., gear assembly 140) is coupled to the frame of the gondola-transfer unit to provide the mechanism for operating the gondola-transfer unit. In some embodiments, this includes connecting gear-assembly arms (e.g., gear assembly arms 141 and 142) to gear-boxes on each L-shaped upper arm (e.g., gear boxes 146 and 147) and to the lifting mechanism already coupled to the horizontal lift arm. In some such embodiments, each L-shaped upper arm already has the necessary gear boxes and crank devices coupled to it.

In some embodiments, blocks 705 through 750 are repeated for each gondola-transfer unit necessary to safely and efficiently lift and move the merchandise gondola (e.g., in some embodiments, seven gondola-transfer units are used for a gondola having a length of approximately 7.32 meters (i.e., 24 feet). In some embodiments, at block 760, when there are two or more gondola-transfer units assembled, the two or more gondola-transfer units are coupled to each other using spreader bars (e.g., spreader bars 260).

At block 765, after the necessary number of gondola-transfer units are fully assembled and coupled to the merchandise gondola, the merchandise gondola is lifted off of the ground with just enough clearance to move the merchandise gondola to a different location (e.g., in some embodiments, the merchandise gondola is lifted off of the ground by about 2.54 centimeters (i.e., 1 inch). After the merchandise gondola is moved, lowered back down to the ground, and uncoupled from the gondola-transfer unit(s), the gondola-transfer unit(s) are moved to the next merchandise gondola or are disassembled. In some embodiments, each gondola-transfer unit can be moved without completely disassembling the gondola-transfer unit (e.g., in some embodiments, the only disassembly necessary to move a fully-assembled gondola-transfer unit is to uncouple the lift brackets from the merchandise gondola and then uncouple the lift bar from the lift-hook assembly).

FIG. 7B is a schematic diagram illustrating some of the blocks from method 700 of FIG. 7A.

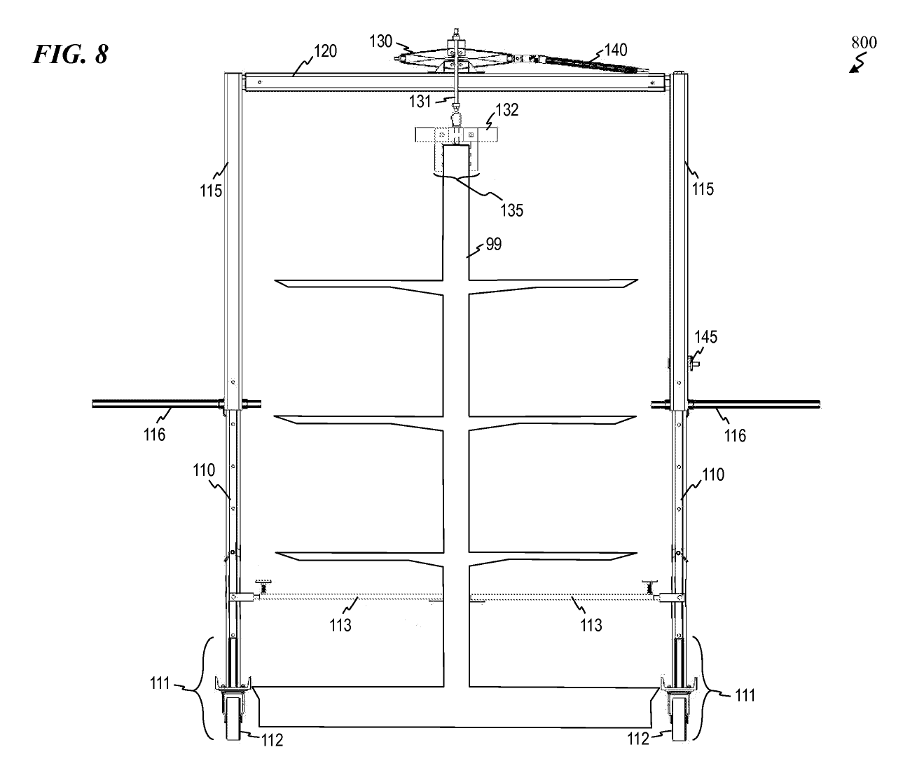

FIG. 8 is an end view of a fully assembled gondola-transfer unit 800 operatively coupled to a merchandise gondola 99 that has been lifted off of the ground by at least the gondola-transfer unit 800. In some embodiments, gondola-transfer unit 800 is substantially similar to gondola-transfer unit 100 described above. In some embodiments, gondola-transfer unit 800 is one of a plurality of gondola-transfer units operatively coupled to merchandise gondola 99 (e.g., in some embodiments, seven individual gondola-transfer units 800 are operatively coupled to merchandise gondola 99).

In some embodiments, the present invention provides an apparatus for lifting and moving a merchandise gondola that includes a first vertical member having at least one wheel at a lower end; a second vertical member having at least one wheel at a lower end; a horizontal member connected at a first end to the first vertical member and connected at a second end to the second vertical member; a gondola coupling device centrally located on the horizontal member; and a mechanical lifting mechanism operatively coupled to the apparatus and configured to lift the gondola coupling apparatus in at least a vertical direction, wherein the mechanical lifting mechanism includes a gear assembly coupled to the apparatus and configured to provide mechanical work to lift the gondola coupling apparatus in the at least vertical direction.

In some embodiments, the gear assembly includes a hand crank. In some embodiments, the mechanical lifting mechanism includes a scissors jack centrally located on the horizontal member and operatively coupled to the gondola coupling device, wherein the scissors jack is further operatively coupled to the gear assembly.

In some embodiments, the gondola coupling device further includes a lift hook assembly operatively coupled to the scissors jack; a lifting bar, wherein the lifting bar includes a hook coupled to a top surface of the lifting bar, and wherein the hook is configured to couple to the lift hook assembly; and a plurality of lifting brackets configured to couple to the lifting bar at a first end of the plurality of lifting brackets and configured to couple to a top surface of the merchandise gondola at a second end of the plurality of lifting brackets.

In some embodiments, the apparatus is one of a plurality of gondola-transfer units operatively coupled to each other including a first gondola-transfer unit and a second gondola-transfer unit. In some embodiments, the apparatus further includes at least one spreader member, wherein the at least one spreader member is configured to couple the first gondola-transfer unit to the second gondola-transfer unit.

In some embodiments, the apparatus further includes at least one sway bar configured to stabilize at least a bottom portion of the merchandise gondola.

In some embodiments, the horizontal member has an adjustable width. In some embodiments, the first and second vertical members have adjustable heights.

In some embodiments, the first vertical member includes two wheels at the lower end of the first vertical member, and the second vertical member includes two wheels at the lower end of the second vertical member.

In some embodiments, the gondola coupling device is configured to couple to the merchandise gondola on a top surface of the merchandise gondola.

In some embodiments, the present invention provides a method for lifting and moving a merchandise gondola that includes providing a first gondola-transfer unit, wherein the first gondola-transfer unit includes a gondola coupling device, a mechanical lifting mechanism, and a plurality of wheels; attaching a top surface of the merchandise gondola to the gondola coupling device; lifting the attached merchandise gondola in at least a vertical direction using the mechanical lifting mechanism; and moving the lifted merchandise gondola from a first location to a second location by rolling the first gondola-transfer unit on the plurality of wheels.

In some embodiments, the mechanical lifting mechanism is a hand-cranked mechanical lifting mechanism. In some embodiments, the mechanical lifting mechanism includes a scissors jack, wherein the lifting of the merchandise gondola includes jacking the gondola coupling device up using the scissors jack.

In some embodiments, the attaching of the gondola coupling device includes hooking the top surface of the merchandise gondola to the gondola coupling device.

In some embodiments, the first gondola-transfer unit is one of a plurality of substantially similar gondola-transfer units including the first gondola-transfer unit and a second gondola-transfer unit, the method further including operatively coupling the first gondola-transfer unit to the second gondola-transfer unit; attaching a top surface of the merchandise gondola to the first gondola-transfer unit and to the second gondola-transfer unit; lifting the attached merchandise gondola using the first gondola-transfer unit and the second gondola-transfer unit; and moving the lifted merchandise gondola from the first location to the second location using the first gondola-transfer unit and the second gondola-transfer unit.

In some embodiments, the method further includes stabilizing at least a bottom portion of the merchandise gondola.

In some embodiments, the method further includes adjusting a height of the first gondola-transfer unit. In some embodiments, the method further includes adjusting a width of the first gondola-transfer unit.

In some embodiments, the present invention provides an apparatus for lifting and moving a merchandise gondola that includes means for coupling a top surface of the merchandise gondola to the apparatus; means for lifting the coupled merchandise gondola in at least a vertical direction; and means for moving the lifted merchandise gondola.

In some embodiments, the means for lifting includes a means for jacking the coupled merchandise gondola in the at least vertical direction.

In some embodiments, the means for coupling includes means for hooking the top surface of the merchandise gondola to the apparatus.

In some embodiments, the apparatus is one of a plurality of gondola-transfer units including a first gondola-transfer unit and a second gondola-transfer unit, the apparatus further including means for coupling the first gondola-transfer unit to the second gondola-transfer unit.

In some embodiments, the apparatus further includes means for stabilizing at least a bottom portion of the merchandise gondola.

In some embodiments, the apparatus further includes means for adjusting a width of the apparatus; and means for adjusting a height of the apparatus.

In some embodiments, the present invention provides an apparatus for lifting and moving a merchandise gondola, the apparatus including a plurality of lift units including a first lift unit and a second lift unit, each lift unit including a substantially vertical first member having at least one wheel at a lower end; a substantially vertical second member having at least one wheel at a lower end; a substantially horizontal third member removably connected at a first end to the first member and removably connected at a second end to the second member; a gondola-coupling device centrally located on the third member and configured to couple to a top surface of a merchandise gondola; and a mechanical-lift mechanism operatively coupled to the lift unit and configured to lift the gondola-coupling device in a vertical direction relative to the third member, wherein the mechanical-lift mechanism includes a rotary assembly coupled to the lift unit and configured to provide a two-way mechanically advantaged connection to the gondola-coupling device from the first member and configured to be actuated to lift the gondola-coupling device by a human operator rotating the rotary assembly from just one side of the lift unit while the first member and the second member remain substantially vertical.

In some embodiments, the mechanical-lift mechanism includes a scissors jack centrally located on the third member and operatively coupled to the gondola-coupling device, wherein the scissors jack is further operatively coupled to the rotary assembly.

In some embodiments, the gondola-coupling device further includes a lift-hook assembly operatively coupled to the scissors jack; a lift bar, wherein the lift bar includes a hook coupled to a top surface of the lift bar, and wherein the hook is configured to couple to the lift-hook assembly; and a plurality of lift brackets including a first lift bracket and a second lift bracket, wherein a first end of the first lift bracket is configured to couple to the lift bar, and wherein a second end of the first lift bracket is configured to couple to a top surface of the merchandise gondola.

In some embodiments, the first lift unit is coupled to the second lift unit with the at least one connector bar. In some embodiments, the at least one connector bar includes a first connector bar and a second connector bar, wherein the first connector bar connects a first side of the first lift unit to a first side of the second lift unit, and wherein the second connector bar connects a second side of the first lift unit to a second side of the second lift unit.

In some embodiments, the apparatus further includes at least one sway bar configured to stabilize at least a bottom portion of the merchandise gondola, wherein a first end of the sway bar is operatively to the first member, and wherein a second end of the sway bar is operatively coupled to the bottom portion of the merchandise gondola.

In some embodiments, the third member has an adjustable width. In some embodiments, the first and second members have adjustable heights.

In some embodiments, the first member includes two wheels at the lower end of the first member, and wherein the second member includes two wheels at the lower end of the second member.

In some embodiments, the gondola-coupling device is configured to couple to the merchandise gondola on a top surface of the merchandise gondola.

In some embodiments, the apparatus further includes a hand crank operatively coupled to the apparatus, wherein the hand crank is operatively coupled to the rotary assembly of each one of the plurality of lift units such that each rotary assembly is configured to be simultaneously actuated to lift a corresponding gondola-coupling device of the plurality of lift units by a human operator rotating the hand crank.

In some embodiments, the present invention provides a method for lifting and moving a merchandise gondola, the method including providing a plurality of lift units including a first lift unit and a second lift unit, wherein each lift unit includes a substantially vertical first member having at least one wheel at a lower end, a substantially vertical second member having at least one wheel at a lower end, a substantially horizontal third member, a gondola-coupling device centrally located on the third member, and a mechanical lifting mechanism operatively coupled to the lift unit, wherein the mechanical lifting mechanism includes a rotary assembly coupled to the lift unit and configured to provide a two-way mechanically advantaged connection to the gondola-coupling device from the first member and configured to be actuated to lift the gondola-coupling device, the method further including removably connecting a first end of the third member of the first lift unit to the first member of the first lift unit; removably connecting a second end of the third member of the first lift unit to the second member of the first lift unit; attaching a first portion of a top surface of the merchandise gondola to the gondola-coupling device of the first lift unit; and lifting the gondola-coupling device in a vertical direction relative to the third member of the first lift unit using the mechanical lifting mechanism of the first lift unit, wherein the lifting includes rotating the rotary assembly of the first lift unit from just one side of the first lift unit while the first member and the second member of the first lift unit remain substantially vertical.

In some embodiments, the method further includes removably connecting a first end of the third member of the second lift unit to the first member of the second lift unit; removably connecting a second end of the third member of the second lift unit to the second member of the second lift unit; attaching a second portion of the top surface of the merchandise gondola to the gondola-coupling device of the second lift unit; removably coupling the first lift unit to the second lift unit; lifting the gondola-coupling device of the second lift unit in a vertical direction relative to the third member of the second lift unit using the mechanical lifting mechanism of the second lift unit, wherein the lifting includes rotating the rotary assembly of the second lift unit from just one side of the second lift unit while the first member and the second member of the second lift unit remain substantially vertical; and moving the coupled first lift unit and second lift unit from a first location to a second location.

In some embodiments, the mechanical lifting mechanism of the first lift unit includes a scissors jack operatively coupled to the rotary assembly of the first lift unit, and wherein the rotating of the rotary assembly actuates the scissors jack such that the gondola-coupling device of the first lift unit is lifted relative to the third member of the first lift unit.

In some embodiments, the gondola-coupling device of the first lift unit includes a plurality of lifting brackets, wherein the attaching of the top surface of the merchandise gondola to the gondola-coupling device of the first lift unit includes coupling the plurality of lifting brackets to the top surface of the merchandise gondola.

In some embodiments, the method further includes providing at least one sway bar, wherein the sway bar includes a first end operatively coupled to the first lift unit and a second end configured to couple to a bottom portion of the merchandise gondola; and stabilizing at least a bottom portion of the merchandise gondola by coupling the second end of the sway bar to the bottom portion of the merchandise gondola.

In some embodiments, the method further includes adjusting a height of the first lift unit. In some embodiments, the method further includes adjusting a width of the first lift unit.

In some embodiments, the method further includes providing a crank device operatively coupled to the plurality of lift units; and simultaneously rotating the rotary assembly of each one of the plurality of lift units using the crank device such that the gondola-coupling device of each one of the plurality of lift units is simultaneously lifted.

In some embodiments, the present invention provides an apparatus for lifting and moving a merchandise gondola, the apparatus including a plurality of lift units including a first lift unit and a second lift unit, wherein each lift unit includes a substantially vertical first member having at least one wheel at a lower end, a substantially vertical second member having at least one wheel at a lower end, a substantially horizontal third member, and a gondola-coupling means centrally located on the third member, the apparatus further including means for removably connecting a first end of the third member of the first lift unit to the first member of the first lift unit; means for removably connecting a second end of the third member of the first lift unit to the second member of the first lift unit; means for attaching a first portion of a top surface of the merchandise gondola to the gondola-coupling means of the first lift unit; and means for lifting the gondola-coupling means of the first lift unit in a vertical direction relative to the third member of the first lift unit while the first member and the second member of the first lift unit remain substantially vertical.

In some embodiments, the apparatus further includes means for removably connecting a first end of the third member of the second lift unit to the first member of the second lift unit; means for removably connecting a second end of the third member of the second lift unit to the second member of the second lift unit; means for attaching a second portion of the top surface of the merchandise gondola to the gondola-coupling means of the second lift unit; means for removably coupling the first lift unit to the second lift unit; means for lifting the gondola-coupling means of the second lift unit in a vertical direction relative to the third member of the second lift unit while the first member and the second member of the second lift unit remain substantially vertical; and means for moving the coupled first lift unit and second lift unit from a first location to a second location.

In some embodiments, the means for lifting includes a means for jacking the gondola-coupling means in the vertical direction.

In some embodiments, the apparatus further includes means for stabilizing at least a bottom portion of the merchandise gondola.

In some embodiments, the apparatus further includes means for adjusting a width of the apparatus; and means for adjusting a height of the apparatus.

In some embodiments, the apparatus further includes means for simultaneously actuating the means for lifting of each one of the plurality of lift units such that the gondola-coupling means of each one of the plurality of lift units is simultaneously lifted.

In some embodiments, the present invention provides an apparatus for lifting and moving a merchandise gondola, the apparatus including a plurality of lift units including a first lift unit and a second lift unit, each lift unit including a substantially vertical first member having at least one wheel at a lower end; a substantially vertical second member having at least one wheel at a lower end; a substantially horizontal third member removably connected at a first end to the first member and removably connected at a second end to the second member; a gondola-coupling device centrally located on the third member and configured to couple to a top surface of a merchandise gondola; and a mechanical-lift mechanism operatively coupled to the lift unit and configured to lift the gondola-coupling device in a vertical direction relative to the third member, wherein the mechanical-lift mechanism includes a hydraulic jack coupled to the lift unit and configured to provide a mechanically advantaged connection to the gondola-coupling device and configured to be actuated to lift the gondola-coupling device while the first member and the second member remain substantially vertical.

In some embodiments, the present invention provides an apparatus for lifting and moving a merchandise gondola, the apparatus including a plurality of lift units including a first lift unit and a second lift unit, each lift unit including a substantially vertical first member having at least one wheel at a lower end; a substantially vertical second member having at least one wheel at a lower end; a substantially horizontal third member removably connected at a first end to the first member and removably connected at a second end to the second member; a gondola-coupling device centrally located on the third member and configured to couple to a top surface of a merchandise gondola; and a mechanical-lift mechanism operatively coupled to the lift unit and configured to lift the gondola-coupling device in a vertical direction relative to the third member, wherein the mechanical-lift mechanism includes an electric jack coupled to the lift unit and configured to provide a mechanically advantaged connection to the gondola-coupling device and configured to be actuated to lift the gondola-coupling device while the first member and the second member remain substantially vertical.

It is specifically contemplated that the present invention includes embodiments having combinations and subcombinations of the various embodiments and features that are individually described herein (i.e., rather than listing every combinatorial of the elements, this specification includes descriptions of representative embodiments and contemplates embodiments that include some of the features from one embodiment combined with some of the features of another embodiment). Further, some embodiments include fewer than all the components described as part of any one of the embodiments described herein.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. An apparatus for lifting and moving a merchandise gondola, the apparatus comprising:
a plurality of lift units including a first lift unit and a second lift unit, each lift unit including:
a substantially vertical first member having at least one wheel at a lower end;
a substantially vertical second member having at least one wheel at a lower end;
a substantially horizontal third member removably connected at a first end to the first member and removably connected at a second end to the second member;
a gondola-coupling device centrally located on the third member and configured to couple to a top surface of a merchandise gondola; and
a mechanical-lift mechanism operatively coupled to the lift unit and configured to lift the gondola-coupling device in a vertical direction relative to the third member, wherein the mechanical-lift mechanism includes a rotary assembly coupled to the lift unit and configured to provide a two-way mechanically advantaged connection to the gondola-coupling device from the first member and configured to be actuated to lift the gondola-coupling device by a human operator rotating the rotary assembly from just one side of the lift unit while the first member and the second member remain substantially vertical.

2. The apparatus of claim 1, wherein the mechanical-lift mechanism includes a scissors jack centrally located on the third member and operatively coupled to the gondola-coupling device, and wherein the scissors jack is further operatively coupled to the rotary assembly.

3. The apparatus of claim 2, wherein the gondola-coupling device further comprises:
a lift-hook assembly operatively coupled to the scissors jack;
a lift bar, wherein the lift bar includes a hook coupled to a top surface of the lift bar, and wherein the hook is configured to couple to the lift-hook assembly; and
a plurality of lift brackets including a first lift bracket and a second lift bracket, wherein a first end of the first lift bracket is configured to couple to the lift bar, and wherein a second end of the first lift bracket is configured to couple to a top surface of the merchandise gondola.

4. The apparatus of claim 1, further comprising at least one connector bar, wherein the first lift unit is coupled to the second lift unit with the at least one connector bar.

5. The apparatus of claim 1, further comprising at least one sway bar configured to stabilize at least a bottom portion of the merchandise gondola, wherein a first end of the sway bar is operatively coupled to the first member, and wherein a second end of the sway bar is operatively coupled to the bottom portion of the merchandise gondola.

6. The apparatus of claim 1, wherein the third member has an adjustable width.

7. The apparatus of claim 1, wherein the first and second members have adjustable heights.

8. A method for lifting and moving a merchandise gondola, the method comprising:
providing a plurality of lift units including a first lift unit and a second lift unit, wherein each lift unit includes:
a substantially vertical first member having at least one wheel at a lower end,
a substantially vertical second member having at least one wheel at a lower end,
a substantially horizontal third member,
a gondola-coupling device centrally located on the third member, and
a mechanical lifting mechanism operatively coupled to the lift unit, wherein the mechanical lifting mechanism includes a rotary assembly coupled to the lift unit and configured to provide a two-way mechanically advantaged connection to the gondola-coupling device from the first member and configured to be actuated to lift the gondola-coupling device, the method further comprising:
removably connecting a first end of the third member of the first lift unit to the first member of the first lift unit;
removably connecting a second end of the third member of the first lift unit to the second member of the first lift unit;
attaching a first portion of a top surface of the merchandise gondola to the gondola-coupling device of the first lift unit; and
lifting the gondola-coupling device in a vertical direction relative to the third member of the first lift unit using the mechanical lifting mechanism of the first lift unit, wherein the lifting includes rotating the rotary assembly of the first lift unit from just one side of the first lift unit while the first member and the second member of the first lift unit remain substantially vertical.

9. The method of claim 8, further comprising:
removably connecting a first end of the third member of the second lift unit to the first member of the second lift unit;
removably connecting a second end of the third member of the second lift unit to the second member of the second lift unit;
attaching a second portion of the top surface of the merchandise gondola to the gondola-coupling device of the second lift unit;
removably coupling the first lift unit to the second lift unit;
lifting the gondola-coupling device of the second lift unit in a vertical direction relative to the third member of the second lift unit using the mechanical lifting mechanism of the second lift unit, wherein the lifting includes rotating the rotary assembly of the second lift unit from just one side of the second lift unit while the first member and the second member of the second lift unit remain substantially vertical; and
moving the coupled first lift unit and second lift unit from a first location to a second location.

10. The method of claim 8, wherein the mechanical lifting mechanism of the first lift unit includes a scissors jack operatively coupled to the rotary assembly of the first lift unit, and wherein the rotating of the rotary assembly actuates the scissors jack such that the gondola-coupling device of the first lift unit is lifted relative to the third member of the first lift unit.

11. The method of claim 8, wherein the gondola-coupling device of the first lift unit includes a plurality of lifting brackets, and wherein the attaching of the top surface of the merchandise gondola to the gondola-coupling device of the first lift unit includes coupling the plurality of lifting brackets to the top surface of the merchandise gondola.

12. The method of claim 8, further comprising:
providing at least one sway bar, wherein the sway bar includes a first end operatively coupled to the first lift unit and a second end configured to couple to a bottom portion of the merchandise gondola; and
stabilizing at least a bottom portion of the merchandise gondola by coupling the second end of the sway bar to the bottom portion of the merchandise gondola.

13. The method of claim 8, further comprising adjusting a height of the first lift unit.

14. The method of claim 8, further comprising adjusting a width of the first lift unit.

15. An apparatus for lifting and moving a merchandise gondola, the apparatus comprising:
a plurality of lift units including a first lift unit and a second lift unit, wherein each lift unit includes:
a substantially vertical first member having at least one wheel at a lower end,
a substantially vertical second member having at least one wheel at a lower end,
a substantially horizontal third member, and
a gondola-coupling means centrally located on the third member, the apparatus further comprising:
means for removably connecting a first end of the third member of the first lift unit to the first member of the first lift unit;
means for removably connecting a second end of the third member of the first lift unit to the second member of the first lift unit;
means for attaching a first portion of a top surface of the merchandise gondola to the gondola-coupling means of the first lift unit; and
means for lifting the gondola-coupling means of the first lift unit in a vertical direction relative to the third member of the first lift unit while the first member and the second member of the first lift unit remain substantially vertical.

16. The apparatus of claim 15, further comprising:
means for removably connecting a first end of the third member of the second lift unit to the first member of the second lift unit;
means for removably connecting a second end of the third member of the second lift unit to the second member of the second lift unit;
means for attaching a second portion of the top surface of the merchandise gondola to the gondola-coupling means of the second lift unit;
means for removably coupling the first lift unit to the second lift unit;
means for lifting the gondola-coupling means of the second lift unit in a vertical direction relative to the third member of the second lift unit while the first member and the second member of the second lift unit remain substantially vertical; and
means for moving the coupled first lift unit and second lift unit from a first location to a second location.

17. The apparatus of claim 15, wherein the means for lifting includes a means for jacking the gondola-coupling means in the vertical direction.

18. The apparatus of claim 15, further comprising means for stabilizing at least a bottom portion of the merchandise gondola.

19. The apparatus of claim 15, further comprising:
means for adjusting a width of the apparatus; and
means for adjusting a height of the apparatus.

20. The apparatus of claim 16, further comprising means for simultaneously actuating the means for lifting of each one of the plurality of lift units such that the gondola-coupling means of each one of the plurality of lift units is simultaneously lifted.
